(19) United States
(12) Patent Application Publication
(10) Pub. No.: US 2023/0166352 A1
(43) Pub. Date: Jun. 1, 2023

(54) LASER PROCESSING OF A WORKPIECE HAVING A CURVED SURFACE

(71) Applicant: TRUMPF Laser- und Systemtechnik GmbH, Ditzingen (DE)

(72) Inventors: Daniel Flamm, Ludwigsburg (DE); Jonas Kleiner, Leonberg (DE)

(21) Appl. No.: 18/163,298

(22) Filed: Feb. 2, 2023

Related U.S. Application Data
(63) Continuation of application No. PCT/EP2021/071896, filed on Aug. 5, 2021.

(30) Foreign Application Priority Data
Aug. 13, 2020 (DE) 10 2020 121 283.6

(51) Int. Cl. B23K 26/06; B23K 26/046; B23K 26/0622

(52) U.S. Cl. CPC B23K 26/0648; B23K 26/046; B23K 26/0622

(57) ABSTRACT

A method for processing a workpiece using a pulsed laser beam includes beam shaping of the laser beam to form an elongated focus zone in the material of the workpiece. The beam shaping is carried out by using an arrangement of diffractive, reflective and/or refractive optical assemblies. The beam shaping includes focus-forming beam shaping to cause beam portions to enter at an entry angle to a beam axis of the laser beam for forming the elongated focus zone along the beam axis in the workpiece by way of interference, and phase-correcting beam shaping to counteract any influence of the interference by entrance of the laser beam into the workpiece. The method further includes setting beam parameters of the laser beam so that the material of the workpiece is modified in the elongated focus zone.

### CROSS REFERENCE TO RELATED APPLICATIONS

This application is a continuation of International Application No. PCT/EP2021/071896 (WO 2022/033958 A1), filed on Aug. 5, 2021 and claims benefit to German Patent Application No. DE 10 2020 121 283.6, filed on Aug. 13, 2020. The aforementioned applications are hereby incorporated by reference herein.

### FIELD

Embodiments of the present invention relate to a method for the material processing of a workpiece having a curved surface, such as a glass tube or a glass cylinder, using a laser beam. Embodiments of the present invention also relate to an optical system and to a laser processing apparatus comprising an optical system.

### BACKGROUND

During the laser processing of a material which is substantially transparent to the laser radiation and is referred to herein as transparent material, laser radiation can be used to generate modifications in the material. In the case of transparent materials, an absorption of the laser radiation that occurs in the volume of the material (volume absorption for short) can bring about an elongated modification of the structure of the material. Modifications in the structure of the material can be used for example for drilling, for separating by way of induced stresses, for bringing about a modification of the refraction behavior or for selective laser etching. In this respect, see for example the applicant's applications WO 2016/079062 A1, WO 2016/079063 A1 and WO 2016/079275 A1.

In this regard, for example, ultrashort-pulse-laser-based glass modification processes for separating glass are often carried out with elongated focus distributions, such as there are for example in nondiffractive beams. Such elongated focus distributions are formed e.g. owing to interference of beam portions entering from outside and can form elongate modifications in the material, as is the case e.g. for Bessel-like beams.

Beam shaping elements and optical setups with which it is possible to provide slender beam profiles which are elongated in the direction of beam propagation and have a high aspect ratio for the laser processing are described for example in the cited WO 2016/079275 A1.

One aspect of this disclosure is based on the object of enabling laser processing of a workpiece having a curved surface such as the laser processing of a glass tube or of a glass cylinder with an elongated focus zone. In particular, beam shaping approaches such as have been developed for the laser processing of plane workpieces are intended to become usable also for workpieces having curved surfaces. A further aspect of this disclosure is based on the object of specifying a method by which a laser-processed body/hollow body can be separated into two portions.

### SUMMARY

Embodiments of the present invention provide a method for processing a workpiece using a pulsed laser beam includes beam shaping of the laser beam to form an elongated focus zone in the material of the workpiece. The beam shaping is carried out by using an arrangement of diffractive, reflective and/or refractive optical assemblies. The beam shaping includes focus-forming beam shaping to cause beam portions to enter at an entry angle to a beam axis of the laser beam for forming the elongated focus zone along the beam axis in the workpiece by way of interference, and phase-correcting beam shaping to counteract any influence of the interference by entrance of the laser beam into the workpiece. The method further includes setting beam parameters of the laser beam so that the material of the workpiece is modified in the elongated focus zone.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows imaging depictions for elucidating nondiffractive beams in comparison with a Gaussian beam according to some embodiments,

FIG. 2 shows a schematic diagram of a laser processing apparatus for material processing according to some embodiments,

FIGS. 3A and 3B show schematic diagrams of an optical system for beam shaping for laser processing according to some embodiments,

FIGS. 4A and 4B show schematic diagrams for elucidating the effect of a curved surface on the formation of a Bessel beam focus zone according to some embodiments,

FIGS. 5A and 5B show intensity distributions of a Bessel beam focus zone which was simulated for entrance into a plane workpiece or for a correction with respect to a curved surface of a workpiece, according to some embodiments,

FIGS. 6A and 6B show intensity distributions of a Bessel beam focus zone without correction with respect to a curved surface, according to some embodiments,

FIG. 7 shows a graphical representation of an exemplary dependence of the radius of curvature of the cylindrical lens on the displacement of the beginning of the focus zone from the workpiece surface, according to some embodiments,

FIG. 8A to 8F show phase distributions for focus-forming beam shapings and phase-correcting beam shapings and phase distributions combining them, according to some embodiments,

FIG. 9 shows a flow diagram for elucidating an exemplary method for the material processing of a workpiece having a curved surface, according to some embodiments,

FIG. 10 shows a flow diagram for elucidating an exemplary method for separating a modified workpiece, according to some embodiments,

FIG. 11 shows a flow diagram for elucidating an exemplary method for separating a workpiece modified with asymmetrically formed modifications, according to some embodiments, and

FIGS. 12A and 12B show exemplary workpieces with cut-out inner contours, according to some embodiments.

### DETAILED DESCRIPTION

Embodiments of the present invention provide methods for the material processing of a workpiece using a pulsed laser beam, in particular using ultrashort laser pulses, wherein the workpiece comprises a material which is largely transparent to the laser beam and has a curved surface. The methods comprise the following steps:

beam shaping of the laser beam in order to form an elongated focus zone (more particularly elongated in the direction of propagation/along a beam axis) in the material of the workpiece, wherein the beam shaping is carried out by an arrangement of diffractive, reflective and/or refractive optical assemblies. The beam shaping comprises:
a focus-forming beam shaping, which causes beam portions to enter at an entry angle to a beam axis of the laser beam for a formation of the elongated focus zone along the beam axis in the workpiece by way of interference, and
a phase-correcting beam shaping, which counteracts any influencing of the interference by entrance of the laser beam into the workpiece, and

setting beam parameters of the laser beam in such a way that the material of the workpiece is modified in the elongated focus zone.

Embodiments of the present invention provide optical systems for the beam shaping of a pulsed laser beam, in particular ultrashort laser pulses, for forming a focus zone in a workpiece having a curved surface, wherein the focus zone is formed in a manner elongated along a beam axis of the laser beam. The optical systems comprise a focus-forming optical assembly, which causes beam portions to enter at an entry angle to a beam axis of the laser beam for a formation of the elongated focus zone along the beam axis in the workpiece by way of interference. A phase correction which counteracts any influencing of the interference by entrance of the laser beam into the workpiece is provided by means of a phase-correcting optical assembly or is integrated into the focus-forming optical assembly. In other words, the optical systems comprise a phase-correcting optical assembly, which brings about a phase correction which counteracts any influencing of the interference by entrance of the laser beam into the workpiece, or such a phase correction is integrated into the focus-forming optical assembly.

Embodiments of the present invention provide laser processing apparatuses for the processing of a workpiece using a pulsed laser beam, in particular using ultrashort laser pulses, by way of modifying a material of the workpiece in a focus zone of the laser beam, wherein the focus zone is formed in elongated fashion along a beam axis of the laser beam and the workpiece comprises a material which is largely transparent to the laser beam and has a curved surface. The laser processing apparatuses comprise a laser beam source, which outputs a laser beam, an optical system as described above, and a workpiece mount for mounting the workpiece.

In some embodiments, the curved surface can be curved in one direction, and the beam shaping of the laser beam can comprise imposing at least one two-dimensional phase distribution on the laser beam in order to form an elongated focus zone in the material of the workpiece, wherein the at least one phase distribution can comprise
for the focus-forming beam shaping, first phase contributions, which cause beam portions to enter at the entry angle (and in particular generate a nondiffractive beam for the formation of the elongated focus zone along the beam axis in the workpiece), and
for the phase-correcting beam shaping, second phase contributions, which cancel an entrance phase locally accumulated by the laser beam during entrance into the workpiece.

In some embodiments, the locally accumulated entrance phase can be determined for an orientation of the beam axis along a normal direction relative to the surface at an impingement point of the beam axis on the surface and can take account of the entry angle, a radius of curvature of the surface at the impingement point and a refractive index of the workpiece.

Generally, the impingement point is understood herein to mean the point of intersection between the optical axis of the laser beam and the workpiece (for example the substrate to be processed).

In some embodiments, the second phase contributions can form a phase distribution which is axially symmetrical with respect to an axis of symmetry, wherein the second phase contributions are constant parallel to the axis of symmetry and vary perpendicular to the axis of symmetry. The methods can furthermore have the following step:

orienting the axially symmetrical phase distribution and the workpiece with respect to one another in such a way that the axis of symmetry taking account of a beam path between a location of the imposing of the axially symmetrical phase distribution and the workpiece runs orthogonally with respect to a plane in which a radius of curvature of the surface is defined.

In some embodiments, the first phase contributions and/or the second phase contributions can be imposed on a transverse beam profile of the laser beam by a diffractive optical beam shaping element, wherein the diffractive optical beam shaping element has mutually adjoining surface elements which construct a planar grating structure in which each surface element is assigned a phase shift value, and wherein the phase shift values bring about the first phase contributions and/or the second phase contributions.

In some embodiments, the methods can furthermore comprise the following steps:

radiating in the laser beam onto the surface along a beam path of an optical system which images the laser beam into the material of the workpiece in order to form the elongated focus zone, and/or

orienting the beam axis of the laser beam with respect to a normal direction relative to the surface in such a way that the beam axis impinges on the surface in an angle range of 5° around the normal direction.

In some embodiments, the phase-correcting beam shaping can be generated by a cylindrical lens positioned upstream or downstream of an optical assembly that brings about the focus-forming beam shaping in a beam path of the laser beam. The cylindrical lens can have a radius of curvature that is adapted to a radius of curvature of the surface of the workpiece.

If it is taken into account that when carrying out the method for material processing, the elongated focus zone already begins upstream of the entrance surface of the workpiece (Δz greater than 0) or the beginning of the elongated focus zone falls in the workpiece (Δz less than 0), this results in the following approximate definitions of the radius of curvature of the surface of the cylindrical lens, which corresponds to the condition presented below in each case for Δz=0:

for Δz≥0 (with the parameters a=5060 mm⁻² and b=9645 mm⁻¹)

$${R}_{z} ( Δ z \geq 0 , {R}_{w} ) \approx ( {n}_{z} - 1 ) \cdot [ ( b - a \cdot {R}_{w} ) \cdot {( Δ z )}^{2} - \frac{{M}^{2} \cdot {R}_{w}}{{n}_{w} - 1} ]$$

for Δz≤0 (with the parameters c=284 mm⁻¹ and d=590):

$${R}_{z} ( Δ z \leq 0 , {R}_{w} ) \approx ( {n}_{z} - 1 ) \cdot [ ( d - c \cdot {R}_{w} ) \cdot Δ z - \frac{{M}^{2} \cdot {R}_{w}}{{n}_{w} - 1} ]$$

in each case where

R_{z} is the radius of curvature/cylinder radius of the cylindrical lens,

n_{z} is the refractive index of the cylindrical lens,

R_{w} is the radius of curvature/outer radius of the surface,

n_{w} is the refractive index of the material of the workpiece, and

M is the imaging factor of the beam path between a location of the focus-forming beam shaping and the workpiece.

In the special case where z=0, the cylindrical lens can have a radius of curvature that is adapted to a radius of curvature of the surface of the workpiece in such a way that the following holds true:

$${R}_{z} \approx ( {n}_{z} - 1 ) \cdot [ \frac{{M}^{2} \cdot {R}_{w}}{{n}_{w} - 1} ]$$

once again where

R_{z} is the radius of curvature/cylinder radius of the cylindrical lens,

n_{z} is the refractive index of the cylindrical lens,

R is the radius of curvature/outer radius Ra of the surface,

n_{w} is the refractive index of the material of the workpiece, and

M is the imaging factor of the beam path between a location of the focus-forming beam shaping and the workpiece.

The above representation of the radius of curvature R_{z} of the surface of the cylindrical lens holds true for the embodiment in which, when carrying out the method for material processing, the beginning of the elongated focus zone coincides with the entrance surface of the workpiece. In other words, there is no displacement Δz of the beginning of the elongated focus zone with respect to the entrance surface (Δz=0). In this special case, the (imaged) axicon tip lies virtually on the surface of the workpiece.

Directly following the tip, however, the nondiffractive beam does not yet have high intensities and continuous processing of the workpiece from the top side as far as the rear side would not be possible. Instead, for example, the (imaged) axicon tip can be placed 100 μm to 200 μm upstream of the surface (Δz in the range of 100 μm to 200 μm, i.e. Δz>0). Accordingly, it would be necessary to use the estimation of the radius of curvature of the cylindrical lens on the basis of the parameters a, b.

In some embodiments, the beam shaping of the laser beam with imposition of a two-dimensional phase distribution on a transverse beam profile of an output laser beam can be carried out by:

a diffractive optical beam shaping element having fixedly set or settable phase values in a two-dimensional arrangement; or
a combination of a cylindrical lens with an axicon; or
a combination of a cylindrical lens with a diffractive optical beam shaping element having fixedly set or settable phase values in a two-dimensional arrangement configured for imposing a phase distribution which brings about a nondiffractive beam, in particular a Bessel-beam-like phase distribution, for the formation of the elongated focus zone.

In some embodiments, the beam shaping of the laser beam can be carried out by a single optical assembly configured as a refractive freeform optical element or as a hybrid optical element, in particular an optical unit comprising an input-side cylindrical lens and an output-side axicon.

In some embodiments, the methods can furthermore comprise the following step:

bringing about a relative movement between the workpiece and the focus zone in the course of which the focus zone is positioned along a scanning trajectory in the material of the workpiece, such that a plurality of modifications are written into the material of the workpiece along the scanning trajectory.

In this case, the workpiece can be configured as a tube, a cylinder or a portion of a tube or cylinder, such as a half-tube or semicylinder, and the relative movement can comprise a rotational movement of the workpiece. The beam axis of the laser beam can run in particular through a longitudinal axis of the workpiece. Furthermore, in the case of a pure rotational movement about a longitudinal axis of the workpiece, the scanning trajectory of the laser beam can run in a plane of the maximum curvature of the surface of the workpiece. Alternatively or supplementarily, a translational movement in the direction of the longitudinal axis of the workpiece can be effected additionally or in portions.

In some embodiments, the scanning trajectory can be an outer contour for subdividing the workpiece into two parts along a longitudinal axis of the workpiece. Alternatively, the scanning trajectory can be configured as an inner contour—closed to a surface of the workpiece—for releasing a region delimited by the inner contour.

In some embodiments, the methods can furthermore comprise the following step:
monitoring and controlling a position of the surface of the workpiece along the beam axis to a target position.

In this case, the monitoring and controlling can be carried out in particular if, in the case of a rotational movement, an axis of rotation deviates from an axis of rotational symmetry of the surface of the workpiece and/or the surface of the workpiece deviates from a rotationally symmetrical surface course at least in portions.

In some embodiments, the methods can furthermore comprise adapting the phase-correcting beam shaping to a change in a curvature of the curved surface along the scanning trajectory of the laser beam. By way of example, a control signal for adapting the phase-correcting beam shaping can be derived on the basis of a prior measurement of a curvature of the curved surface along the trajectory and/or on the basis of an online measurement of a curvature of the curved surface during a relative movement between the workpiece and the focus zone along the scanning trajectory. The control signal can then be output to a settable beam shaping element such as to a spatial light modulator or to a deformable mirror in order to adapt the second phase contributions for the phase-correcting beam shaping.

In some embodiments, the optical systems can be designed to impose a two-dimensional phase distribution on the laser beam and to output the latter as a laser beam that shapes a nondiffractive beam, more particularly a real or virtual Bessel-like laser beam, wherein the focus-forming optical assembly can generate first phase contributions of the phase distribution, and the phase-correcting optical assembly or the phase correction can generate second phase contributions of the phase distribution, which cancel an entrance phase locally accumulated by the laser beam during entrance into the workpiece.

In some embodiments of the optical systems, the focus-forming optical assembly and/or the phase-correcting optical assembly for the phase imposition of a two-dimensional phase distribution can be configured as a diffractive optical beam shaping element designed to impose the first phase contributions and/or the second phase contributions on a transverse beam profile of the laser beam. The diffractive optical beam shaping element can have mutually adjoining surface elements which construct a planar grating structure in which each surface element is assigned a phase shift value, and wherein the phase shift values bring about the first phase contributions and/or the second phase contributions. Alternatively or additionally, the focus-forming optical assembly can be configured as an axicon, which generates the focus-forming phase contributions. Furthermore, alternatively or additionally, the phase-correcting optical assembly can be configured as a cylindrical lens, which generates the second phase contributions and is positioned directly upstream or downstream of the focus-forming optical assembly in the beam path of the laser beam. Alternatively or additionally, the focus-forming optical assembly can be configured as a refractive freeform element, which generates the first phase contributions and the second phase contributions.

Alternatively or additionally, the focus-forming optical assembly and the phase-correcting optical assembly can be configured as a hybrid optical assembly, which generates the first phase contributions and the second phase contributions and is configured in particular as a combination of an input-side cylindrical lens and an output-side axicon.

In some embodiments of the optical systems, the phase-correcting optical assembly for the phase imposition of a two-dimensional phase distribution can be configured as an optical element which is settable in terms of the two-dimensional phase distribution. By way of example, it can be configured as a diffractive optical beam shaping element such as a spatial light modulator or a deformable cylindrical mirror. Furthermore, the settable optical element can be configured for adapting the phase corrections in the event of a change in a curvature to be corrected of the curved surface depending on a control signal.

In some embodiments, the optical systems can furthermore comprise:

a telescope arrangement for reducing a real or virtual focus zone, which is assigned to the focus-forming optical assembly, and/or

a distance sensor designed to determine a position of a surface of the workpiece along the beam axis.

In some embodiments of the laser processing apparatuses, the optical system and/or the workpiece mount can be designed:

to orient the beam axis of the laser beam with respect to a normal direction relative to the surface in such a way that the beam axis impinges on the surface in an angle range of 5° around the normal direction, preferably along the normal direction, and/or

to bring about a relative movement between the workpiece and the focus zone in the course of which the focus zone is positioned along a scanning trajectory in the material of the workpiece, wherein the orientation of the beam axis with respect to the normal direction is adapted to the course of the surface.

In some embodiments, the laser processing apparatuses furthermore comprise

a distance sensor arranged and designed to determine a position of a surface of the workpiece along the beam axis, and

a controller designed to monitor a position of the surface of the workpiece along the beam axis by means of the distance sensor and to control it to a target position.

In some embodiments of the laser processing apparatuses, the optical system can have a phase-correcting optical assembly for the phase imposition of a two-dimensional phase distribution, which is configured as settable in terms of the two-dimensional phase distribution.

For this purpose, the laser processing apparatus can furthermore comprise a controller designed to output to the settable optical element a control signal which adapts the two-dimensional phase distribution to a curvature to be corrected of the curved surface of the workpiece. The control signal can be provided, in particular derived by the control unit, in particular on the basis of a prior measurement of a curvature of the curved surface along a scanning trajectory or on the basis of an online measurement of a curvature of the curved surface during a relative movement between the workpiece and the focus zone along a scanning trajectory.

In some embodiments, the laser processing apparatuses can furthermore have a distance sensor arranged and designed to determine a position of a surface of the workpiece along the beam axis.

Furthermore, the laser processing apparatuses can have a controller designed to monitor a position of the surface of the workpiece along the beam axis by means of the distance sensor and to control it to a target position.

A process for the laser processing of transparent materials having curved surfaces can be implemented in accordance with the embodiments disclosed herein. The embodiments allow for example the processing of glass tubes having radii smaller than 15 mm, e.g. having radii of a few millimetres, such as 5 mm, in elongated focus zones of from a few 10 μm to a few millimeters.

The embodiments described herein concern a focus-forming beam shaping, which causes beam portions to enter at an entry angle to a beam axis of the laser beam for a formation of the elongated focus zone along the beam axis in the workpiece by way of interference. In other words, the focus-forming beam shaping concerns beam shaping which generates a nondiffractive beam for forming the elongated focus zone along the beam axis in the workpiece.

The aspects described herein relate in particular to the application of nondiffractive beams during material processing. Nondiffractive beams can be formed by wave fields which satisfy the Helmholtz equation

∇²U(r)+k²U(r)=0 (equation 1)

and have a clear separability into a transverse (i.e. in the x- and y-directions) dependence and a longitudinal (i.e. in the z-direction/direction of propagation) dependence of the form

U(x,y,z)=U^{t}(x,y)exp(ik_{z}z) (equation 2).

In this case, k=ω/c is the wave vector with its longitudinal/axial and transverse components k²=k_{z}²+kₜ² and U^{t}(x, y) is an arbitrary complex-valued function which is dependent only on the transverse coordinates x and y. Since the z-dependence in equation 2 has a pure phase modulation, an intensity I(x, y, z) of a function that solves the equation 2 is propagation-invariant and is referred to as “nondiffractive”:

I(x,y,z)=|U(x,y,z)|²=I(x,y,0) (equation 3)

This approach provides different classes of solutions to the Helmholtz equation in different coordinate systems, for example so-called Mathieu beams in elliptic-cylindrical coordinates or so-called Bessel beams in circular-cylindrical coordinates.

In this respect, see also J. Turunen and A. T. Friberg, “Propagation-invariant optical fields”, in Progress in optics, 54, 1-88, Elsevier (2010) and M. Woerdemann, “Structured Light Fields: Applications in Optical Trapping, Manipulation, and Organisation”, Springer Science & Business Media (2012).

A large number of types of nondiffractive beams can be realized to a good approximation. For the sake of simplicity, these nondiffractive beams that are realized will be referred to herein further as “finitely delimited nondiffractive beams”, “nondiffractive beams”, or else as “quasi-nondiffractive beams”. In contrast to the theoretical construct, they carry a finite power. A length L of a propagation invariance that is assigned to them is also likewise finite.

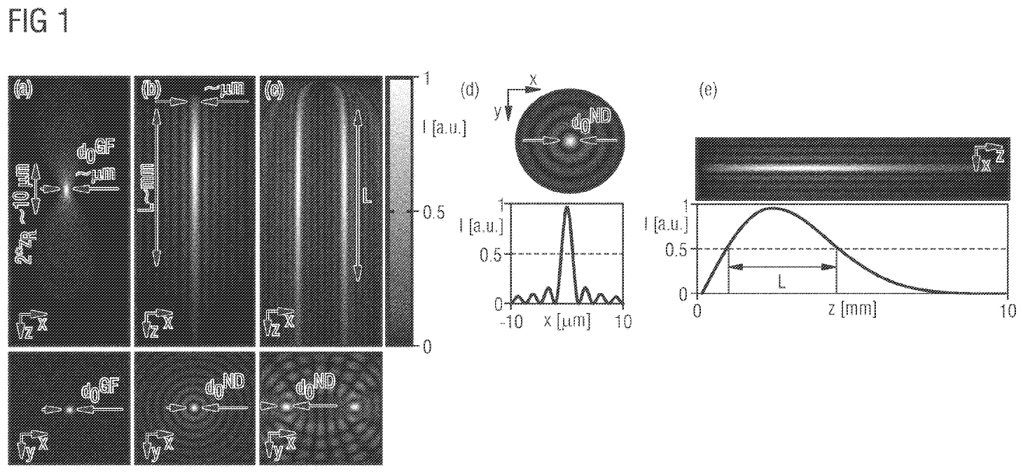

FIG. 1 shows, in comparison with intensity representations of a conventional Gaussian focus (see the propagation behavior of a Gaussian focus in imaging depiction (a) in FIG. 1), the propagation behavior of nondiffractive beams on the basis of intensity representations in imaging depictions (b) and (c). The imaging depictions (a), (b) and (c) each show a longitudinal section (x-z-plane) and a transverse section (x-y-plane) through the focus of a Gaussian beam and of nondiffractive beams which propagate in the z-direction.

The imaging depiction (b) relates by way of example to a rotationally symmetrical nondiffractive beam, here a Bessel-Gaussian beam. The imaging depiction (c) relates by way of example to a non-asymmetrical nondiffractive beam. For a Bessel-Gaussian beam, the imaging depictions (d) and (e) in FIG. 1 furthermore show details of a central intensity maximum. In this regard, imaging depiction (d) in FIG. 1 shows an intensity profile in a transverse sectional plane (X-Y-plane) and a transverse intensity profile in the X-direction. The imaging depiction (e) in FIG. 1 shows details of the central intensity maximum in a section in the direction of propagation.

A focus diameter d₀^{GF} of the Gaussian focus is defined for the comparison, the Gaussian focus being defined by way of the second moments. Furthermore, an associated characteristic length is defined by way of the Rayleigh length z_{R}=π(d₀^{GP})²/4λ, which is defined as a distance proceeding from the focus position at which the beam cross-section has increased by a factor of 2. Furthermore, for a quasi-nondiffractive beam, a transverse focus diameter d₀^{ND} is defined as the transverse dimension of a local intensity maximum, the transverse focus diameter d₀^{ND} being given by the shortest distance between directly adjacent, opposite intensity minima (e.g. intensity decrease to 25%). In this respect, see e.g. the imaging depictions (b) and (d) in FIG. 1. The longitudinal extent of the almost propagation-invariant intensity maximum can be regarded as a characteristic length L of the quasi-nondiffractive beam. It is defined by way of an intensity decrease to 50%, proceeding from the local intensity maximum, in each case in the positive and negative z-direction, see imaging depictions (c) and (e) in FIG. 1.

A quasi-nondiffractive beam is assumed herein if, for similar transverse dimensions, e.g. d₀^{ND}≈d₀^{GF} the characteristic length L of the nondiffractive beam distinctly surpasses the Rayleigh length of the associated Gaussian focus, particularly if L>10_{z}_{_{R}}.

(Quasi-)Bessel beams, also known as Bessel-like beams, are examples of a class of (quasi-)nondiffractive beams. In the case of such beams, the transverse field distribution U^{t}(x, y) in the vicinity of the optical axis obeys to a good approximation a Bessel function of the first kind of order n. A subset of this class of beams is the so-called Bessel-Gaussian beams, which are widely used owing to the simple generability thereof. A Bessel-Gaussian beam can be shaped e.g. by illuminating an axicon of refractive, diffractive or reflective embodiment with a collimated Gaussian beam. An associated transverse field distribution in the vicinity of the optical axis in the region of an associated elongated focus zone here obeys to a good approximation a Bessel function of the first kind of order 0 (to a good approximation) which is enveloped by a Gaussian distribution, see imaging depictions (d) and (e) in FIG. 1, the intensity distribution shown corresponding to the square of the absolute value of a Bessel function (to a good approximation).

Typical Bessel-Gaussian beams which can be used for the processing of transparent materials have diameters of the central intensity maximum on the optical axis of

d₀^{ND}=2.5 μm. The associated length L can readily exceed 1 mm, see imaging depiction (b) in FIG. 1. By contrast, a focus of a Gaussian beam where d₀^{GF}≈d₀^{ND}=2.5 μm is distinguished by a focal length in air of just z_{R}≈5 μm at a wavelength λ of 1 μm, see imaging depiction (a) in FIG. 1. In these cases that are relevant to material processing, the following accordingly even holds true for the associated length L:L>>10z_{R}, for example 100 or more times or even 500 or more times the Rayleigh length.

Aspects described herein are based in part on the insight that, if the intention is to process a workpiece having a curved surface using a nondiffractive beam such as forms for example in an interference-based focus zone of a Bessel-Gaussian beam, the curved surface can affect the formation of the nondiffractive beam (of the underlying interference). Accordingly, beam shaping such as is used for processing plane workpieces is no longer expedient. This is the case particularly if the curvature is not rotationally symmetrical, but rather is embodied one-dimensionally, as in the case of a tube or cylinder to be processed that is composed of e.g. glass or a transparent ceramic.

It has furthermore been recognized that it is possible to compensate for this influencing of the nondiffractive beam in a processing step such that then even beam shaping concepts or beam shaping components developed for plane workpieces can be used for forming the nondiffractive beam with specific phase impositions, for example.

In other words, the inventors have recognized that a curved surface leads to aberrations during the propagation of the laser radiation and spatial properties of a nondiffractive beam, e.g. of a Bessel-beam-like beam profile, no longer form. By way of example, such nondiffractive beams can no longer be used over the full length sought for the formation of material modifications.

In order to maintain the formation and properties of the nondiffractive beam, for example with a Bessel-beam-like beam profile, it is proposed herein to counteract the aberrations that occur upon entrance into the workpiece by means of a phase correction. In this case, the phase correction is performed in the beam path preferably in the region in which a Gaussian or almost Gaussian laser beam profile is still present. The phase correction can be effected in particular in the region of a phase imposition such as is used for forming the nondiffractive beam, e.g. a Bessel-beam-like beam profile, in workpieces. In the case of a quadratically curved surface oriented symmetrically with respect to the pulsed laser beam, the phase correction can be brought about using simple optical components. The geometries of the optical components required for the correction become very complex even just for tilted surfaces.

In this regard, it has been recognized that despite aberrations that occur upon entrance into a workpiece, it is possible to generate a nondiffractive beam with an almost undisturbed propagation in the material of a tube or cylinder. When the phase correction is performed, using a pulsed laser beam with correspondingly set parameters such as pulse energy, pulse duration and focus zone geometry, elongated modifications can also be written into a workpiece having a curved surface. Structural modifications generated in this way can enable a separating process or be used for material removal, as in the case of plane workpieces.

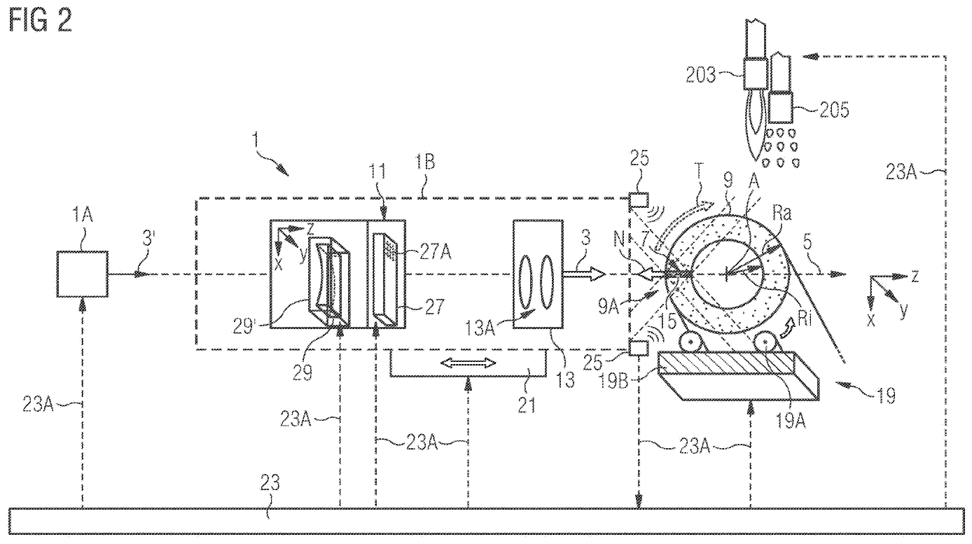

FIG. 2 shows a schematic illustration of a laser processing apparatus 1 comprising a laser beam source 1A and an optical system 1B for the beam shaping of a pulsed output laser beam 3′ of the beam source 1A. The beam shaping serves to form a pulsed laser beam 3 with a beam profile which is focusable into a focus zone 7 for material processing as a nondiffractive beam. In other words, the focus zone 7 is formed by the nondiffractive beam and the focus zone 7 is formed in elongated fashion along a beam axis 5 of the laser beam 3.

The focus zone 7 is generated in a workpiece to be processed. The workpiece can consist for example of a transparent material (largely transparent to the laser wavelength of the pulsed laser beam 3 used) of e.g. ceramic or crystalline embodiment such as glass, sapphire, transparent ceramic, glass ceramic. Transparency of a material herein relates to the linear absorption. For light below the threshold fluence/intensity, a “substantially” transparent material can absorb e.g. less than 20% or even less than 10% of the incident light for example on a length of a modification.

In FIG. 2, a (e.g. glass) tube 9 is indicated three-dimensionally as an example of a workpiece having a curved surface 9A. The tube 9 has an outer radius Ra and an inner radius Ri and also a wall thickness Ra-Ri. In FIG. 2, the beam axis 5 is directed at the surface 9A along a normal direction N relative to the surface 9A and impinges on said surface at an impingement point P.

Generally, the output laser beam 3′ and thus the laser beam 3 are determined by beam parameters such as formation of individual laser pulses or groups of laser pulses, wavelength, spectral width, temporal pulse shape, pulse energy, beam diameter and polarization. For the material processing, the laser pulses have for example pulse energies resulting in pulse peak intensities which bring about a volume absorption in the material of the tube wall and therefore a formation of a modification in a desired geometry.

The output laser beam 3′ will usually be a collimated Gaussian beam with a transverse Gaussian intensity profile, said beam being generated by the laser beam source 1A, for example a USP high-power laser system. From the Gaussian beam, the optical system 1B shapes a beam profile which enables the formation of the elongated focus zone 7; for example, a Bessel-Gaussian beam with a customary or inverse Bessel-beam-like beam profile is generated with the aid of a beam shaping element 11 of the optical system 1B. The beam shaping element 11 is configured for imposing a transverse phase profile on the incident output laser beam 3′. The beam shaping element 11 is e.g. a hollow cone axicon, a hollow cone axicon lens/mirror system, a reflective axicon lens/mirror system or a diffractive optical beam shaping element. The diffractive optical beam shaping element can be a programmable or permanently written diffractive optical beam shaping element, in particular a spatial light modulator (SLM). For exemplary configurations of the optical system and, in particular, of the beam shaping element 11, reference is made to WO 2016/079275 A1, cited in the introduction.

FIG. 2 schematically shows further beam guiding components 13 as part of the optical system 1B, such as, for example, a telescope arrangement 13A, mirrors, lenses, filters, and control modules for orienting the various components.

The optical system 1B focuses the pulsed laser beam 3 into the workpiece, here into the wall of the tube 9, such that the elongated focus zone 7 forms there. The elongated focus zone 7 herein relates to a three-dimensional intensity distribution which determines in the workpiece to be processed the spatial extent of the interaction and thus of the modification of the material with the laser pulse/laser pulse group. The elongated focus zone 7 determines an elongated volume region in the workpiece to be processed in which a fluence/intensity is present. If the fluence/intensity is above the threshold fluence/intensity relevant to the processing/modification, an elongated modification 15 is written into the workpiece along the elongated focus zone 7.

With regard to laser processing, elongated focus zones is the term used if a three-dimensional intensity distribution with respect to a target threshold intensity is characterized by an aspect ratio (ratio of the extent in the propagation direction to the lateral extent transversely with respect to the focus zone axis (diameter of the on-axis maximum)) of at least 10:1, for example 20:1 or more, or 30:1 or more, or 1000:1 or more. Such an elongated focus zone can result in the modification 15 in the material with a similar aspect ratio. In general, in the case of such aspect ratios, a maximum change in the lateral extent of the intensity distribution which effects the modification 15 over the focus zone 7 can be in the range of 50% or less, for example 20% or less, for example in the range of 10% or less. The same applies, mutatis mutandis, to a maximum change in the lateral extent of the modification 15.

It is generally true for the processing of transparent materials by means of elongated volume absorption that, as soon as an absorption takes place, this absorption itself, or else the resultant changing of the material property, can influence the propagation of laser radiation. Therefore, it is advantageous to feed the beam portions that serve for the modification further downstream of the beam to the zone of interaction at an angle with respect to the focus zone axis. One example of such an energy feed is the nondiffractive beam, for example a (conventional) Bessel-Gaussian beam (see FIG. 1), in which a ring-shaped far field distribution is present, the ring width of which is typically small in comparison with the radius. In the case of a rotationally symmetrical Bessel-Gaussian beam, radial beam portions are fed to the zone of interaction/focus zone axis substantially at this angle rotationally symmetrically. This is similarly true for the inverse Bessel-Gaussian beam and for modifications such as homogenized, asymmetrical or modulated (inverse) Bessel beams.

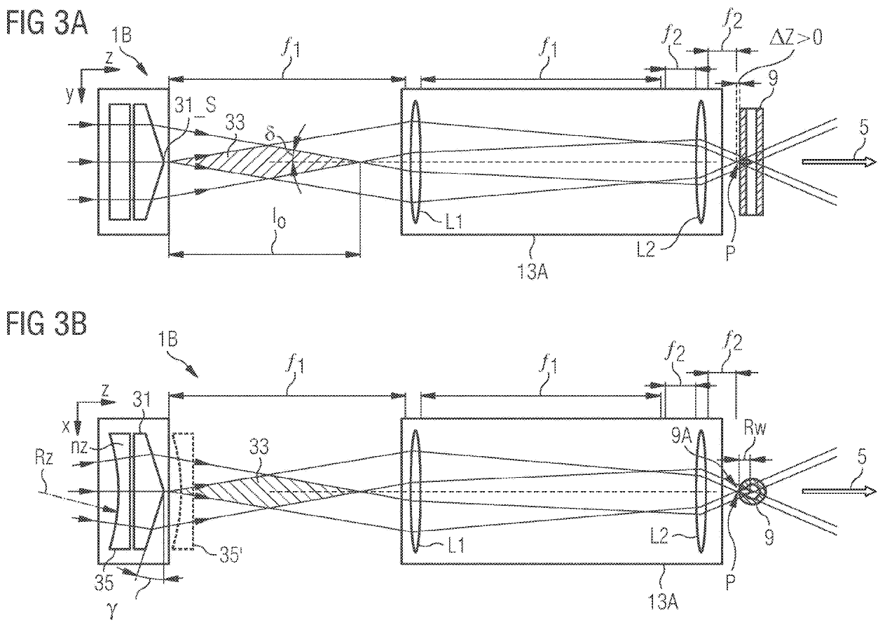

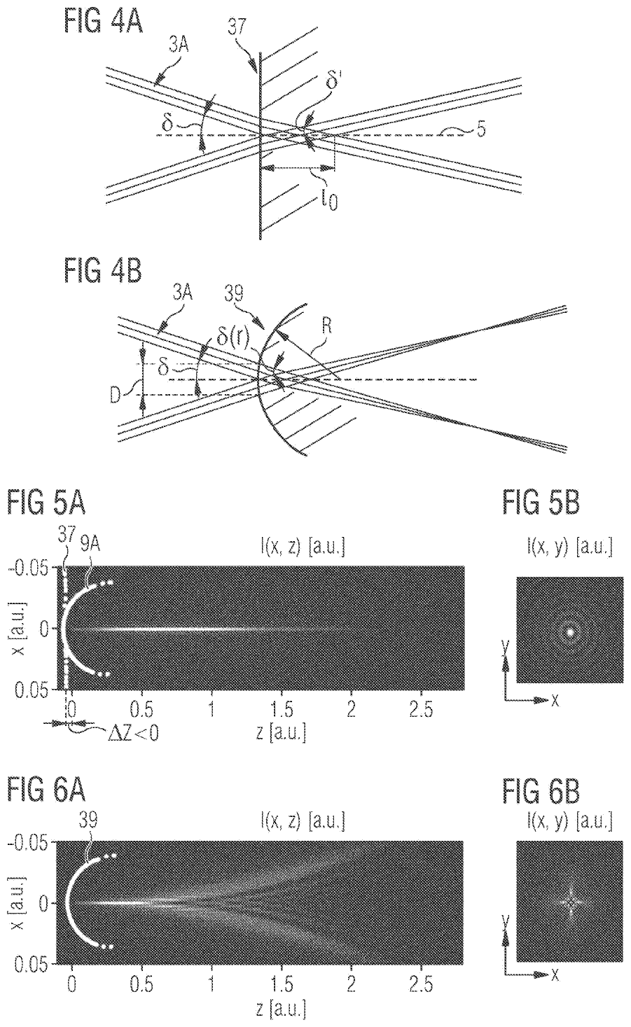

An exemplary beam shaping which results in such an elongated focus zone is elucidated in FIGS. 3A to 6B. The figures show by way of example in a sectional plane through the beam path an entry of (radial) beam portions 3A (see FIG. 4B, in particular) at an entry angle δ in air or δ′ in the material to the beam axis 5 of the laser beam 3. In this regard, the elongated focus zone 7 can be formed along the beam axis 5 in the workpiece by way of interference of the beam portions 3A (over a length L, see FIG. 1).

The formation of an elongated (e.g. Bessel-beam-based) focus zone presupposes that over the entire length L of the focus zone energy can be fed in laterally and the conditions for constructive interference are present.

For the processing of the workpiece, a relative movement is effected between the optical system 1B and the workpiece, with the result that, in the case of a pulsed laser beam, the focus zone 7 can be radiated into the workpiece at various positions in order to form an arrangement of modifications 15. The relative movement is controlled in such a way that the modifications line up along a scanning trajectory T. The arrow elucidating the scanning trajectory T in FIG. 2 is representative of a movement of the impingement point P over the surface of the workpiece (by way of example in the plane of the drawing in FIG. 1, i.e. the sectional plane of the tube 9). In particular, a relative movement between the workpiece and the focus zone 7 is brought about in the course of which the focus zone 7 is repeatedly positioned along the scanning trajectory T (at least partly) in the material of the workpiece. Accordingly, a plurality of modifications can be written into the material of the workpiece along the scanning trajectory T.

For circumferential processing of the tube 9 (circumferential scanning trajectory T), a workpiece mount 19 is shown in FIG. 2, and allows the tube 9 to be mounted rotatably about a longitudinal axis A of the tube 9. Supporting rollers 19A are indicated by way of example. Furthermore, a base unit 19B of the workpiece mount 19 can allow the tube 9 to be displaced along the longitudinal axis A or can set the distance with respect to the optical system 1B.

Alternatively or supplementarily, a relative movement between workpiece and optical system 1B can be brought about by movement of the optical system 1B (or of components thereof). A linear displacement unit 21 of the optical system 1B is shown by way of example in FIG. 2, and enables the focus zone to be positioned along the beam axis. Further processing axes can be provided, allowing the emerging laser beam 3 and thus the focus zone axis to be oriented in space.

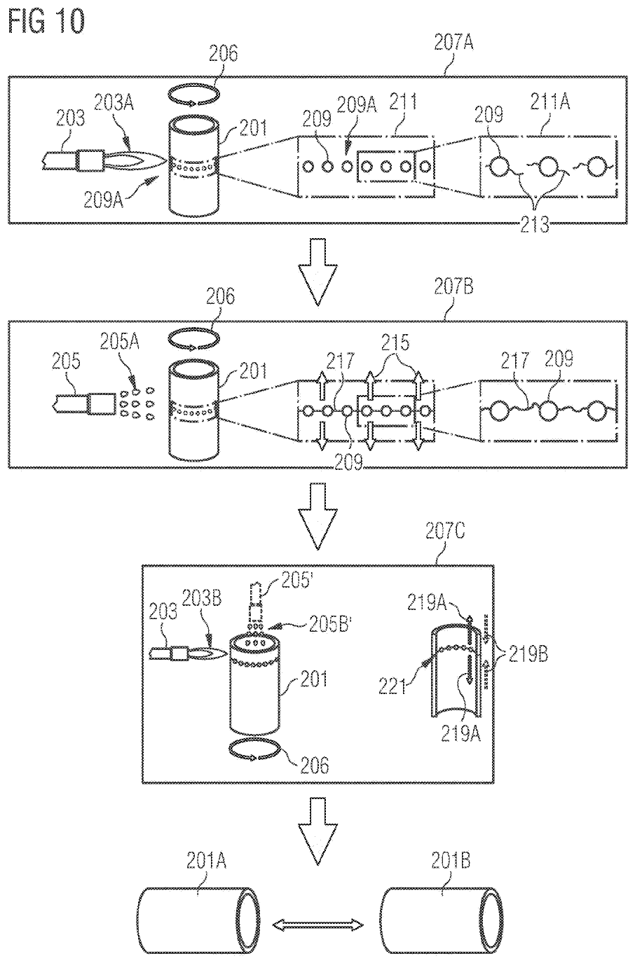

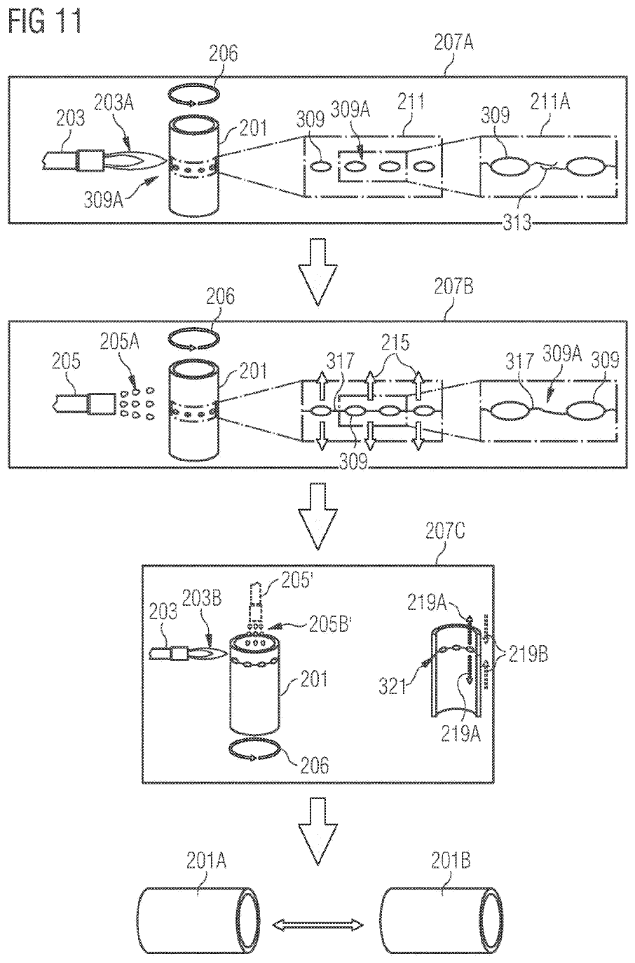

Separation of a tube piece or cutting out of structures from the tube piece can be brought about, depending on the scanning trajectory T. As will be explained in this respect in association with FIGS. 10 and 11, this can be effected e.g. using a heat source 203 and a cooling source 205.

The laser processing apparatus 1 furthermore has a control unit 23, which has in particular an interface for the inputting of operating parameters by a user. Generally, the control unit 23 comprises electronic control components such as a processor for controlling electrical, mechanical and optical components of the laser processing apparatus 1. By way of example, operating parameters of the laser beam source 1A such as e.g. pump laser power, parameters for the setting of an optical element (for example of an SLM) and parameters for the spatial orientation of an optical element of the optical system 1B and parameters of the workpiece mount 19 (for traversing the scanning trajectory T) can be set (elucidated by double-headed arrows 23A).

Furthermore, a distance sensor 25 arranged on the optical system 1, for example, is indicated schematically in FIG. 2. The distance sensor 25 is designed to detect the distance between the workpiece and the optical system. In particular, the distance sensor 25 can determine a position of a surface 9A of the workpiece 9 along the beam axis 5 in relation to a target position with respect to the elongated focus zone. The target position is defined for the specific material processing situation of the respective workpiece and for the respective beam shaping. By way of example, the target position can be specified by a desired displacement Δz (in or counter to the direction of propagation of the laser beam) between a beginning of the elongated focus zone and the surface of the workpiece/tube 9. The beginning of the elongated focus zone can lie for example at that location in the Z-direction at which the intensity has risen to 50% of the maximum intensity. Besides the beginning of the elongated focus zone coinciding with the surface of the workpiece, it is possible for the target position set to be a displacement Δz>0, in the case of which the elongated focus zone already forms upstream of the tube 9 and then extends into the material of the tube 9. It is likewise possible to set a displacement Δz<0, in the case of which the elongated focus zone forms only in the material of the tube or at least in a manner beginning in the material of the tube 9.

The distance sensor 25 outputs distance data to the control unit 23, which can control the distance in relation to a predefined target position for example by way of the workpiece mount 19 or the linear displacement unit 21. Distance sensors can be configured e.g. as confocal white light sensors, white light interferometers (such as optical coherence tomographs) or capacitive sensors.

In particular, the distance sensor 25 can be used to measure the position of a workpiece relative to a processing optical assembly and/or the geometry of the workpiece in a prior measurement step or during the processing. By way of example, it may happen that the rotating workpiece (to be positioned) is mounted in the workpiece mount 19 in a manner such that it wobbles slightly, in particular severely, during a rotation. In such a case, the distance between the surface and the predefined target position can be measured prior to the actual processing and the position data of the surface can be stored. For this purpose, the control unit 23 can cause the workpiece to be traversed once along the trajectory to be processed, without the laser beam 3 being radiated in. During this prior measurement, the distance sensor 25 detects the distance data and outputs them to the control unit 23, in which the distance data are stored.

Furthermore, the distance sensor 25 can be configured to measure a curvature of the surface of the workpiece in a prior measurement step or during the processing. The curvature can be calculated from the distance data, for example. By way of example, the curvature of the surface of the workpiece may vary along the scanning trajectory, such that the scanning trajectory is traversed in a prior measurement in order to store data about the curvature of the surface along the scanning trajectory and to use them for a later setting of the phase-correcting beam shaping. A corresponding prior measurement can in turn be controlled by the control unit 23 and the curvature data acquired can be stored in the control unit 23.

Furthermore, the control unit 23 can set parameters of the laser beam 3.

Exemplary parameters of the laser beam 3 which can be used in the context of this disclosure, in particular in the case of the various herein disclosed aspects and embodiments, which preferably use pulsed laser radiation, and in particular ultrashort laser pulses, for the material processing are:

laser pulse energies/energy of a laser pulse group (burst): e.g. in the mJ range or more, for example in the range of between 20 μJ and 5 mJ (e.g. 1200 μJ), typically between 100 μJ and 1 mJ

wavelength ranges: IR, VIS, UV (for example 2 μm>λ>200 nm; for example 1550 nm, 1064 nm, 1030 nm, 515 nm, 343 nm)

pulse duration (FWHM): a few picoseconds (for example 3 ps) or shorter, for example a few hundred or a few (tens of) femtoseconds, in particular ultrashort laser pulses/laser pulse groups

number of laser pulses in a burst: e.g. 2 to 4 pulses (or more) per burst with a temporal spacing in the burst of a few nanoseconds (e.g. 40 ns)

number of laser pulses per modification: one laser pulse or a burst for one modification

repetition rate: usually greater than 0.1 kHz, e.g. 10 kHz length of the focus zone in the material: greater than 20 μm, up to a few millimeters

diameter of the focus zone in the material: greater than 1 μm, up to 20 μm or more

(resulting lateral extent of the modification in the material: greater than 100 nm, e.g. 300 nm or 1 μm, up to 20 μm or more)

advancement d between two adjacent modifications: at least the lateral extent of the modification in the advancing direction (usually at least double the extent, for example four times or ten (or more) times the extent)

The pulse duration here relates to an individual laser pulse. Accordingly, an exposure time relates to a group/burst of laser pulses which result in the formation of a single modification at one location in the material of the workpiece. If the exposure time, like the pulse duration, is short with respect to an advancing rate present, one laser pulse and all of the laser pulses of a group of laser pulses contribute to a single modification at one location. Continuous modification zones comprising modifications adjoining one another and merging into one another may also arise at a relatively low advancing rate.

The abovementioned parameter ranges may allow the processing of volumes which project up to, for example, 20 mm or more (typically 100 μm to 10 mm) into a workpiece. Such volumes are used e.g. during the processing of tubes having inner radii of 100 μm or greater and outer radii of e.g. in the range of 10 mm.

In FIG. 2, the beam shaping is implemented using a planar diffractive optical beam shaping element 27.

In FIG. 2, the concepts disclosed herein for phase correction with respect to the curved surface 9A of the workpiece are implemented by way of a cylindrical lens 29. A cylinder axis assigned to the cylindrical lens extends along the axis A of the tube 9 in FIG. 2. Furthermore, FIG. 2 schematically indicates that the cylindrical lens 29 can be configured as a phase distribution of a cylindrical mirror (deformable in a settable manner) or of a diffractive optical beam shaping element 29′. In this case, the diffractive optical beam shaping element 29′ can be configured as a permanently written diffractive optical beam shaping element. Furthermore, the diffractive optical beam shaping element 29′ can be configured as a settable diffractive optical beam shaping element. Furthermore, the diffractive optical beam shaping element 27 and the diffractive optical beam shaping element 29′ can be combined in one diffractive optical beam shaping element. A settable diffractive optical beam shaping element or a deformable cylindrical mirror can be controlled and set by the control unit 23 with respect to the phase-correcting beam shaping to be performed (see connecting line 23A in FIG. 2).

Generally, a diffractive optical beam shaping element is configured to impose a phase contribution on a transverse beam profile of the output laser beam 3′, the diffractive optical beam shaping element having mutually adjoining surface elements (see surface elements 27A indicated by way of example for the beam shaping element 27 in FIG. 2). The surface elements 27A can construct a planar grating structure in which each surface element 27A is assigned a phase shift value. By way of example, an axicon or an inverse axicon, but also a cylindrical lens can be simulated diffractively with the aid of specially chosen phase shift values.

Diffractive optical beam shaping elements and corresponding refractive optical assemblies and also reflective optical assembly implementations are regarded herein as optical means which are substantially equivalent with respect to the phase correction to be performed.

FIGS. 3A and 3B show orthogonal sectional views of the beam path (only schematic, not physical) in an optical system for elucidating the beam shaping. FIG. 3A shows a sectional view in a Z-Y-plane, and FIG. 3B shows a sectional view in a Z-X-plane.

The processing optical assembly is used for (Gaussian-)Bessel beam generation and comprises an axicon 31 having a cone angle γ, such that radial beam portions each pass at an angle S toward the beam axis 5 and form a first real Bessel beam focus zone (interference zone 33 over a length 10). The axicon 31 is embedded in two telescopes. An upstream positioned telescope (not shown) adapts the beam diameter of the output laser beam 3′ to the axicon 31, generally the beam shaping element. FIGS. 3A and 3B explicitly show the downstream positioned telescope arrangement 13A having telescope lenses L1 and L2 and focal lengths f1 and f2, by means of which the axicon tip 31_S is imaged in reduced fashion (reduction factor M=f1/f2) in relation to the curved surface of the workpiece. The general aim of the imaging is for the interference zone 33 to be imaged into the workpiece in reduced fashion for the formation of the elongated focus zone 7 (of the nondiffractive laser beam). The nondiffractive laser beam impinges on the workpiece surface at an impingement point P. Generally, the impingement point is understood herein to mean the point of intersection between the optical axis of the laser beam and the workpiece (for example the substrate to be processed). If the axicon tip 31_S is imaged onto the curved surface, there is no displacement Δz of the beginning of the nondiffractive laser beam with respect to the entrance surface (i.e. Δz=0). In the example in FIG. 3A, the beginning of the nondiffractive laser beam lies upstream of the surface of the workpiece by a magnitude Δz>0, for example Δz lies in the range of 100 μm to 200 μm, such that a sufficient intensity for processing the material is already present at the workpiece surface. Referring to FIG. 5A, it is also possible for the nondiffractive laser beam not to begin until in the workpiece (Δz<0).

After the imaging and entrance into the workpiece, the radial beam portions pass in the Z-Y-plane in the material for example at an angle δ′ toward the beam axis 5.

This is shown for a plane surface 37 in FIG. 4A (ideal propagation; without aberrations). The interference of the radial beam portions 3A takes place over the entire length.

An exemplary intensity profile I(x, z) such as can be generated using a Bessel beam is shown along the beam axis 5 (in the Z-direction) in FIG. 5A. An associated transverse intensity profile I(x, y) is shown in FIG. 5B. The intensity profiles correspond to those of the imaging depiction (b) in FIG. 1.

The aim is for such an intensity profile also to be achieved for a workpiece having a curved surface 9A. However, this is not possible without a correction of the optical path in the plane of curvature.

FIG. 4B (disturbed propagation; with aberrations) elucidates the problem for the entrance of a Bessel-beam-shaped laser beam into a material through a curved surface 39. On account of the curvature (i.e. a locally inclined incidence), the radial beam portions pass in the material at varying angles δ(r) toward the beam axis 5. The interference conditions are present only at the start in the case of the Bessel beam (only at the end in the case of the inverse Bessel beam) on account of the still approximately plane surface in the central region around the beam axis. This is the situation for example for a surface having a radius of curvature R of 5 mm and a diameter D of the impinging laser beam 3 of e.g. 250 μm to 2 mm.

An exemplary intensity profile I(x, z) is shown in FIGS. 6A and 6B for this situation of entrance through a curved surface. FIG. 6A shows an intensity profile I(x, z). It is evident that high intensities are present only over a limited region along the beam axis 5 (in the Z-direction); zones of somewhat higher intensity subsequently form at a distance from the beam axis 5. In the associated transverse intensity profile I(x, y) in FIG. 6B, it is evident that these off-axis zones are arranged in the X- and Y-directions.

The wavefront aberrations during passage through the curved surface 39 thus result in a focus distribution with a significant loss of intensity in the direction of propagation, with the result that optical processing of in particular deeper regions no longer becomes possible.

Returning to FIG. 3B, owing to the curved surface 9A of the tube 9 in the Z-X-plane, a nondiffractive beam extending over the entire envisaged length (i.e. a constructive interference in, in particular, deeper regions) is no longer formed without compensation in the Z-X-plane, since the conditions with respect to interference in the workpiece differ from those in the interference zone 33. The desired intensity distribution is thus no longer generated in the workpiece without compensation.

Assuming that the phase compensation concept proposed herein has been performed, the correction phase influences the course of the laser beam in the material in such a way that the radial beam portions in the Z-X-plane, too, likewise pass substantially at the angle δ′ toward the beam axis 5.

For phase compensation purposes, a cylindrical lens 35 is positioned upstream of the axicon 31 in the setup in FIGS. 3A and 3B, the refractive effect of which lens lies in the cross-sectional plane of the tube 9. In order to elucidate an alternative arrangement, a cylindrical lens 35′ is indicated in a dashed manner in FIG. 3B, this lens being positioned directly downstream after the axicon 31 in the beam path in the processing optical assembly. The cylindrical lens 35, 35′ represents the location at which an axially symmetrical phase distribution is imposed.

The cylindrical lens has a refractive index nz, a cylinder radius Rz and a focal length fz in order to compensate for aberrations of the workpiece having a radius of curvature Ra of the surfaces and a refractive index nw.

Apart from the cylindrical lens 35, the optical assemblies in the setup in FIGS. 3A and 3B should be understood as rotationally symmetrical about the beam axis 5 in the case of a rotationally symmetrical axicon 31.

Owing to the cylindrical lens 35, the interference will no longer form rotationally symmetrically downstream of the axicon 31, since e.g. the conditions in the interference zone 33 in the Z-Y-plane differ from those in the Y-X-plane.

The optical systems shown in FIG. 2 and in FIGS. 3A and 3B are examples of an optical system for the beam shaping of a laser beam for forming a focus zone in a workpiece having a curved surface, wherein the focus zone is configured in elongated fashion along a beam axis of the laser beam. In this case, the optical systems comprise firstly a focus-forming optical assembly, which causes beam portions to enter at an entry angle to a beam axis of the laser beam for a formation of the elongated focus zone along the beam axis (i.e. for a formation of a nondiffractive beam) in the workpiece by way of interference. Secondly, a phase correction is provided in the optical system, and counteracts any influencing of the interference by entrance of the laser beam into the workpiece. The phase correction can generally be implemented in diffractive, refractive and/or reflective fashion. It can for example be provided as a phase-correcting (separate) optical assembly or be integrated into the focus-forming optical assembly.

For the use of a cylindrical lens 35, 35′ as a compensation optical assembly, the cylindrical lens 35, 35′ should be situated as close as possible in the plane of the axicon or of the diffractive optical element (beam shaping element 27) (if possible directly upstream or downstream thereof).

The choice of the radius of curvature Rz of the surface of the cylindrical lens depends on the relative position of the nondiffractive beam with respect to the workpiece, in particular on the beginning of the elongated focus zone with respect to the entrance surface of the workpiece.

For the case where there is no displacement Δz of the beginning of the elongated focus zone with respect to the entrance surface (Δz=0), the radius of curvature R_{z} of the cylindrical lens is calculated to a good approximation from fz≈Rw M²/(n−1) and fz≈Rz/(nz−1)

$${R}_{z} \approx ( {n}_{z} - 1 ) \cdot [ \frac{{M}^{2} \cdot {R}_{w}}{{n}_{w} - 1} ]$$

with

R_{z}: radius of curvature of the cylindrical lens,

n_{z}: refractive index of the cylindrical lens,

R_{w}: radius of curvature of the surface of the workpiece,

n_{w}: refractive index of the material of the workpiece, and

M M=f1/f2—imaging factor of the beam path between a location of the imposition of the phase distribution and the workpiece.

If it is taken into account that the elongated focus zone begins upstream of the entrance surface of the workpiece (Δz greater than 0) or falls in the workpiece (Δz less than 0), this results in the following approximate definitions of the radius of curvature R_{z} of the surface of the cylindrical lens, which corresponds to the above condition in each case for Δz=0:

Δz>0 (with the additional parameters a=5060 mm⁻² and b=9645 mm⁻¹):

$${R}_{z} ( Δ z \geq 0 , {R}_{w} ) \approx ( {n}_{z} - 1 ) \cdot [ ( b - a \cdot {R}_{w} ) \cdot {( Δ z )}^{2} - \frac{{M}^{2} \cdot {R}_{w}}{{n}_{w} - 1} ]$$

Δz≤0 (with the additional parameters c=284 mm⁻¹ and d=590):

$${R}_{z} ( Δ z \leq 0 , {R}_{w} ) \approx ( {n}_{z} - 1 ) \cdot [ ( d - c \cdot {R}_{w} ) \cdot Δ z - \frac{{M}^{2} \cdot {R}_{w}}{{n}_{w} - 1} ]$$

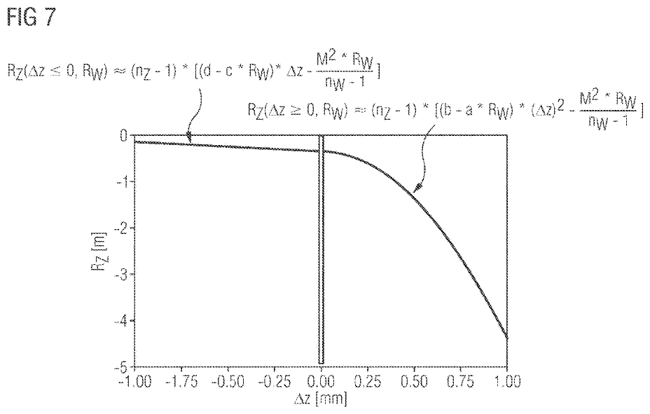

The graph represented in FIG. 7 shows an exemplary function (constituted from definitions above) of the radius of curvature R_{z} as a function of the displacement Δz, assuming the following parameters:
imaging factor of the optical system M=10,
refractive index of the material of the workpiece n_{w}=1.5,
radius of curvature of the surface of the workpiece R_{w}=3.5 mm,
refractive index of the cylindrical lens n_{z}=1.5.

The approximate linear profile for Δz<0 and the approximately quadratic profile for Δz>0 are evident.

As indicated in FIG. 2, accordingly in the case of a “positively” curved small glass tube (convex in the sectional plane), a “negative” cylindrical lens curvature (concave) should be provided. In other words, a phase distribution caused by the cylindrical lens has a diverging effect (rather than a converging effect such as occurs upon entrance into the small glass tube). A person skilled in the art will recognize that with the concepts disclosed herein, even workpieces having a concavely curved surface (for example for laser processing along a rod having a groove) can be processed by providing a “positive” cylindrical lens curvature (convex).

Radii of curvature herein are generally considered in a sectional plane transversely with respect to the longitudinal axis of the workpiece/tube portion to be cut. A radius of curvature for a workpiece having a convex shape in the sectional plane (round tube surface) is inverse relative to a concave shape. The curvature of the correcting optical assemblies (or a “curvature” assignable to the corresponding phase profiles) is correspondingly inverted with respect to the curvature of the workpiece. This is indicated in the above formula by the factor (−1). A radius of curvature R_{z} less than zero/negative cylindrical lens for a concave shape of the workpiece is evident in FIG. 7. Accordingly, a radius of curvature R_{z} greater than zero/positive cylindrical lens arises for a convex shape of the workpiece. A person skilled in the art will recognize that besides planoconvex or planoconcave cylindrical lenses (see FIG. 2), it is possible to use corresponding lenses curved on both sides with the corresponding refraction behavior.

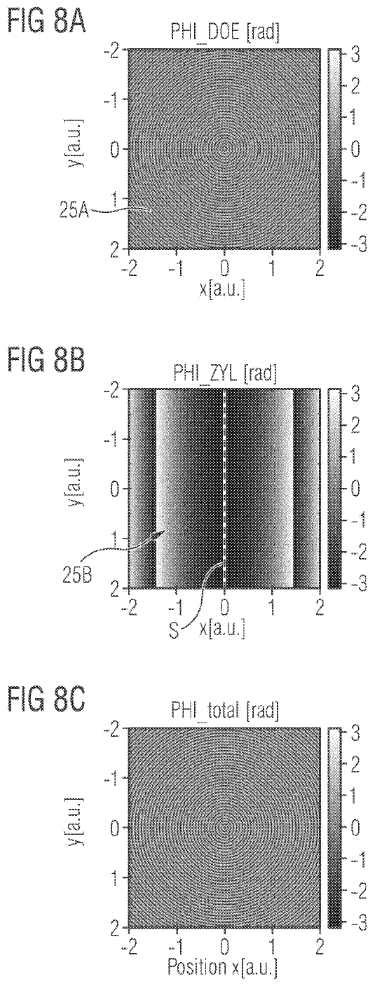

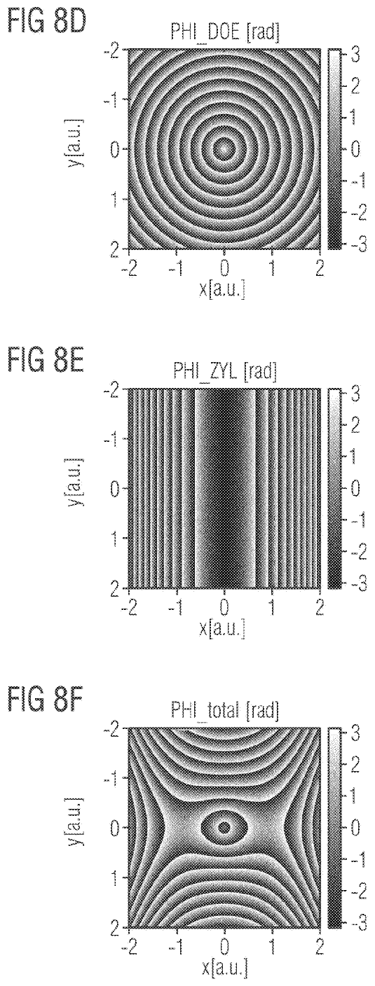

As will furthermore be recognized by a person skilled in the art, diffractive optical beam shaping elements and/or refractive and/or reflective optical assemblies can be used for the phase correction to be performed. Phase distributions of embodiments with diffractive optical beam shaping elements are explained below with reference to FIGS. 8A to 8F.

For a realistic laser processing case on the basis of phase profiles such as to respond to a 2° axicon and a 1000 mm cylindrical lens, exemplary phase distributions are shown in FIGS. 8A to 8C for central segments of e.g. 1 inch diameter DOEs. Since the phase distribution for the 2° axicon dominates the combined phase distribution, for elucidation purposes FIGS. 8D to 8F show an exemplary case on the basis of phase profiles such as can be assigned to a 0.5° axicon and a 200 mm cylindrical lens.

FIG. 8A shows a two-dimensional phase distribution PHI_BESSEL(x, y) [in rad] for a diffractive optical element which brings about focus-forming beam shaping. In particular, the phase distribution PHI_BESSEL(x, y) can impose a symmetrical Bessel beam phase distribution on an incident Gaussian beam (in order to generate a Bessel-Gaussian beam). The phase distribution PHI_BESSEL(x, y) reveals constant phase shift values progressing in a ring-shaped fashion and progressing radially in a sawtooth shape between −PI and +PI. The phase shift values represent first phase contributions 25A of the beam shaping and cause beam portions to enter at an entry angle to a beam axis of the laser beam for a formation of an elongated focus zone along the beam axis in the workpiece by way of interference. The elongated focus zone approximately corresponds to the focus zone generated by means of a 2° axicon (γ=2°).

FIG. 8B shows a two-dimensional phase distribution PHI_CYL(x, y) for a diffractive optical element which brings about phase-correcting beam shaping such as can be used in the processing of a tube having an outer radius of 5 mm with an elongated focus zone such as is generated with the phase distribution PHI_BESSEL(x, y). The phase profile approximately corresponds to that of a 1000 mm cylindrical lens having a cylinder radius of “Rz≈−500 mm”.

Phase shift values which are constant in the Y-direction are evident which in the X-direction progress (rise) in a sawtooth-like shape between −PI and +PI quadratically in the x-direction and represent second phase contributions 25B of the beam shaping. The second phase contributions 25B form a phase distribution that is symmetrical with respect to an axis of symmetry S, wherein the second phase contributions 25B are constant parallel to the axis of symmetry S (in the y-direction) and vary perpendicular to the axis of symmetry S.

Assuming an imaging factor M=10 and correspondingly customary refractive indices for the cylindrical lens and the tube, the second phase contributions 25B can cancel the entrance phase accumulated by a laser beam upon entrance into the tube having the outer radius of 5 mm locally, i.e. on a surface element on the curved surface.

The two-dimensional phase distribution PHI_BESSEL(x, y) and the phase distribution PHI_CYL(x, y) can be generated in combination by means of one diffractive optical element. FIG. 8C shows a corresponding superposed two-dimensional phase distribution PHI_total (x, y), in which the two-dimensional phase distribution PHI_BESSEL(x, y) dominates the appearance.

In order to elucidate the appearance of a superposition of a point-symmetrical phase profile for the Bessel beam generation of an axially symmetrical phase profile for the phase correction, FIG. 8D shows a phase distribution PHI_BESSEL(x, y) for generating an elongated focus zone which approximately corresponds to the focus zone generated by a 0.5° axicon. FIG. 8E shows a two-dimensional phase distribution PHI_CYL(x, y), the phase profile of which approximately corresponds to that of a 200 mm cylindrical lens having a cylinder radius of approximately −100 mm.

In FIG. 8F, the superposed two-dimensional phase distribution PHI_total(x, y) then reveals a corresponding deformation of the phase distribution PHI_BESSEL(x, y). With the phase distribution PHI_BESSEL(x, y) in FIG. 8F, a tube having an outer radius of 1 mm (given M=10) could be processed. It is noted once again that the parameters underlying FIGS. 8D to 8F are intended to be used purely for elucidating the phase profiles and not so much to represent a realistic example.

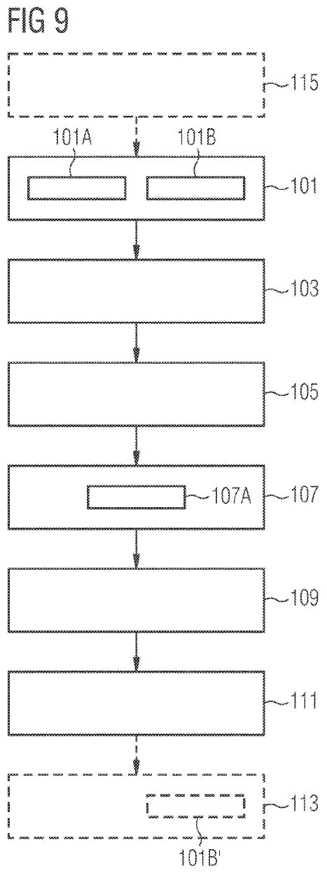

FIG. 9 shows a flow diagram of a method for the laser processing of a workpiece having a curved surface.

A step 101 involves beam shaping of a laser beam in order to form an elongated focus zone in the material of the workpiece. The beam shaping is carried out by means of an arrangement of diffractive and/or refractive and/or reflective optical assemblies. Step 101 comprises the sub-steps of focus-forming beam shaping 101A and phase-correcting beam shaping 101B.

The focus-forming beam shaping 101A causes beam portions to enter at an entry angle to a beam axis of the laser beam for a formation of the elongated focus zone along the beam axis in the workpiece by way of interference.

The phase-correcting beam shaping 101B counteracts any influencing of the interference by entrance of the laser beam into the workpiece.

Steps 101A and 101B can also be carried out in combination in a common phase imposition step. In this regard, in step 101, a two-dimensional phase distribution can be imposed on the laser beam in order to form the elongated focus zone, wherein the phase distribution comprises for the focus-forming beam shaping first phase contributions, which cause beam portions to enter at the entry angle, and/or for the phase-correcting beam shaping second phase contributions, which cancel an entrance phase locally accumulated by the laser beam during entrance into the workpiece. The accumulated entrance phase is determined for an orientation of the beam axis along a normal direction relative to the surface at an impingement point of the beam axis on the surface. It takes account of the entry angle (δ′), the radius of curvature Rw of the surface of the workpiece at the impingement point, and the refractive index nw of the workpiece (in particular of the material in the region of the beam entrance of the workpiece).

A step 103 can involve orienting the symmetrical phase distribution and the workpiece in such a way that an axis of symmetry of the phase distribution of the second phase contributions taking account of the beam path between a location of the imposing of this axially symmetrical phase distribution and the workpiece runs orthogonally with respect to a plane in which a (maximum) radius of curvature of the surface is defined.

A step 105 involves setting beam parameters of the laser beam in such a way that the material of the workpiece is structurally modified in the elongated focus zone.

A step 107 involves radiating in the laser beam onto the surface of the workpiece along a beam path which images the laser beam into the material of the workpiece in order to form the elongated focus zone. In this case, it is possible to orient the beam axis of the laser beam with respect to a normal direction relative to the surface (step 107A) in such a way that the beam axis impinges on the surface in an angle range of 5° around the normal direction and preferably along the normal direction.

With respect to steps 103 and 107, it is possible to carry out an alignment process, for example by means of the arrangement described in the applicant's German patent application 10 2020 103 884.4, “Alignment device for a Bessel beam processing optical assembly and method”, with a filing date of Feb. 14, 2020.

For the laser processing, e.g. the axicon tip 31_S (see FIG. 2) as the beginning of the elongated focus zone can be virtually imaged on the surface of the tube 9 (Δz=0). Alternatively, the beginning of the elongated focus zone can lie upstream of the surface of the tube 9 (Δz>0) or only in the tube 9 (Δz<0). Assuming a correspondingly adapted choice of the radius of curvature, the positioning of the optical system with respect to the workpiece preferably in the direction of beam propagation (along the beam axis) can have a z-position tolerance of a few 100 micrometers, e.g. ±200 μm.

For the alignment, an alignment cylindrical lens can be used as workpiece substitute (front side curved like the tube to be processed, rear side plane). A correspondingly accurate exchange should be made possible for the laser processing. On the front side of the cylindrical lens, a marking can be applied, for example metal by means of vapor deposition or a symbol by means of painting. A telescope is arranged downstream of the alignment cylindrical lens, the focal plane of said telescope being recorded by a camera for the imaging of the surface.

In a first step of the alignment process, the camera is focused on the surface of the alignment cylindrical lens, such that the marking is sharply imaged.

In a second step of the alignment process, the processing optical unit is oriented with respect to the surface of the alignment cylindrical lens. In this case, it is necessary to align both a transverse position (in the X/Y-direction) and a longitudinal position (in the Z-direction).

For the transverse positioning, the tube is displaced from the beam path in opposite directions, the edges of the lens on both sides being readily detectable and the mean value yielding the transverse position.

The longitudinal positioning involves searching for the virtual plane of the Gaussian envelope of the raw beam on the axicon. If the test cylindrical lens is too close, the camera identifies the Bessel beam focus zone; if the test cylindrical lens is too far away, the camera already identifies the ring distribution. The largely correct position in the Z-direction is afforded if the envelope of the beam profile is configured to be as far as possible circular and not elliptical. The plane rear side of the test cylindrical lens produces almost no aberration in the camera image.

In a second step of the alignment process, by way of a reference in the Z-position, the cylindrical lens is replaced with the workpiece, e.g. a small glass tube.

In a step 109, a relative movement between the workpiece and the focus zone is brought about in the course of which the focus zone is positioned along a scanning trajectory in the material of the workpiece. Accordingly, a plurality of modifications can be written into the material of the workpiece along the scanning trajectory.

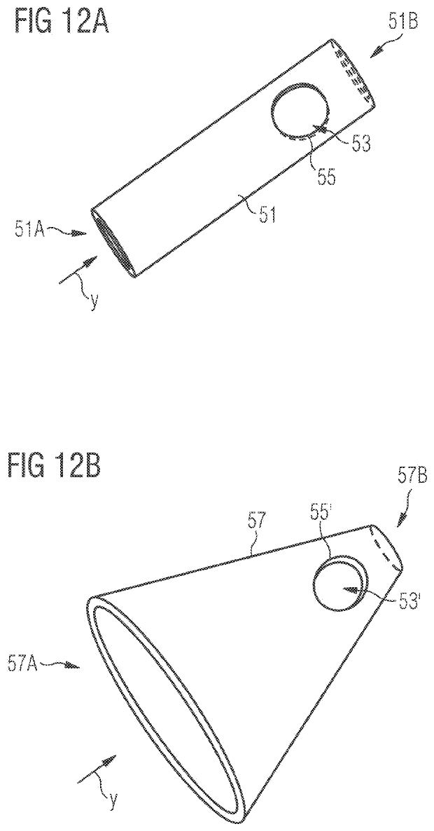

The relative movement in step 109 can be controlled as a rotational movement of the workpiece in the course of which the beam axis of the laser beam passes in particular through a longitudinal axis of the workpiece. In the case of a pure rotational movement about a longitudinal axis of the workpiece, the scanning trajectory of the laser beam can run in a plane of the maximum curvature of the surface of the workpiece. Alternatively or additionally, it is possible to control a translational movement in the direction of the longitudinal axis of the workpiece in order to traverse arbitrary scanning trajectories on the surface of the workpiece. By way of example, it is possible to traverse an outer contour for subdividing the workpiece 9 into two parts along a longitudinal axis of the workpiece 9 (see the example in FIG. 2) or an inner contour—closed to a surface of the workpiece 9—for releasing a region delimited by the inner contour (see the example in FIG. 12A). Furthermore, the scanning trajectory can run in one or more regions with (substantially) identical curvature in the surface and/or in one or more regions with varying curvature of the surface.

A step 111 involves monitoring a position of the surface of the workpiece along the beam axis and controlling it to a target position (target distance from the optical system). The monitoring and controlling are carried out in particular if an axis of rotation of the rotational movement deviates from an axis of rotational symmetry of the surface of the workpiece and/or the surface of the workpiece deviates from a rotationally symmetrical surface course at least in portions.

If the trajectory runs in a region with varying curvature, a step 113 can involve adapting a phase-correcting beam shaping 101B′ in terms of its compensation effect in regard to the surface curvature respectively present. Consequently, for the surface curvature respectively present, it is possible to counteract any influencing of the interference by the entrance of the laser beam into the workpiece. The adaptation of the phase-correcting beam shaping is effected for example by taking account of the curvature respectively present in the two-dimensional phase distribution of the beam shaping element. See, for example, the workpiece having a conically tapering workpiece surface as illustrated in FIG. 12B, into which workpiece a sequence of modifications is intended to be written along a closed inner contour. By way of example, the second phase contributions 25B provided for such a phase correction can be correspondingly adapted in a settable SLM. Alternatively, for example, the curvature of a deformable mirror can be adapted.

The adaptation can be effected for example on the basis of measurements which are carried out during the beam processing. A correspondingly rapid analysis unit for the geometry of the workpiece should be provided. Alternatively or supplementarily, a step 115 can involve carrying out a prior measurement of the geometry of the workpiece along the scanning trajectory. For the prior measurement, the laser processing apparatus can traverse for example the scanning trajectory to be traversed for the material processing without activation of the laser beam source 1A for the measurement of the geometry of the workpiece.

Separate optical assemblies for the beam shaping and the phase compensation are shown by way of example in the examples discussed above. However, these optical assemblies can also be implemented in a single optical assembly (e.g. as a refractive/reflective freeform element or as a diffractive optical element) or in a hybrid optical element (input side cylindrical lens, output side axicon; “Zaxicon”).

Furthermore, e.g. the long-focal-length lens f1 of the telescope 13A can be concomitantly included in a hybrid axicon or in a diffractive optical element. As an alternative to the imaging of a real focus zone (such as a Bessel-beam-like focus zone), a virtual focus zone (such as an inverse Bessel-beam-like focus zone) can be imaged by means of the telescope 13A.

Workpieces such as tubes, cylinders or portions of a tube or cylinder, such as a half-tube or semicylinder, can be processed by means of the processing methods described herein.

A workpiece into which a plurality of modifications that are spaced apart or merge into one another have been introduced is present as a result of the laser-based workpiece processing. In the case of a tube, said modifications are introduced circumferentially (see FIG. 2) in order to subdivide the tube into 2 portions (scanning along a circumferential outer contour), for example. Furthermore, modifications can be introduced into a curved surface along an inner contour (see FIGS. 12A and 12B). The modifications can additionally form cracks in the material which extend into the material of the workpiece between adjacent modifications or generally randomly proceeding from one of the modifications.

The above-explained methods for the material processing of a workpiece using a laser beam can constitute a first portion of a process for separating a workpiece having a curved surface into two parts. After the material processing using the laser beam has concluded, although the workpiece has been provided with many modifications in the material, often there is still a sufficient connection composed of non-modified material between the two parts. Accordingly, a second portion of the separating process is necessary, in which these remaining connections are released in order to attain the complete separation of the workpiece into two parts.

A supplementary consideration with respect to the second separating process is that a modification in the context of this disclosure constitutes a structural alteration of the material of the workpiece which converts the material e.g. from a non-etchable state of the non-modified material into an etchable state of the modified material. Accordingly, modifications can be characterized in particular by an increase in wet-chemical etchability in comparison with the non-modified material. Accordingly, a separation of the glass tube into two parts can be attained in the context of a wet-thermal etching process. Such wet-chemical etching processes can be used in particular for detaching material regions that were cut out along an inner contour.

A further approach for separating a workpiece into two parts may be based on the fact that a modification of the material may be accompanied by a formation of a likewise elongated cavity. If this is the case, and if a sufficient number of cavities have been formed circumferentially in the glass tube, it is possible for (in particular spontaneous) breaking of the glass tube to occur along a weakening line formed by the sequence of cavities.

A further approach for separating a workpiece with a sequence of modifications uses thermally induced, thermally assisted and/or thermally augmented cracking. In association with FIGS. 10 and 11, such an exemplary thermal separation process for processed workpieces will be explained on the basis of the example of a glass tube 201, wherein the glass tube 201 was modified with the aid of a nondiffractive beam along a circumferential trajectory for example at equally spaced positions.

For a thermally assisted separating process, the laser processing apparatus shown in FIG. 2 can additionally comprise a heat source 203 and/or a cooling source 205. Alternatively, the heat source 203 and/or the cooling source 205 can be provided in the context of an independent separating device having the correspondingly required degrees of freedom. The heat source 203 and the cooling source 205 are configured to heat or to cool the glass tube 201 in particular in the region of the modifications. For this purpose, it is possible to perform local heating/cooling in combination with a rotation of the glass tube (indicated by the arrow 206 in FIG. 10). Local heating can be effected for example by means of a localized flame directed at the workpiece, or a CO2 laser beam radiated onto the workpiece. By way of example, (local or large-area) cooling can be effected by means of a water-gas mixture which is sprayed onto the workpiece or flows for example through a cavity of the workpiece.

The separation process can comprise three sub-steps 207A, 207B, 207C. The latter are schematically elucidated in FIGS. 10 and 11 for the case where a glass tube 201 is subdivided into glass tube parts 201A, 201B. In the separation process, the glass tube 201 is thermally influenced in such a way that the glass tube 201 separates into the two glass tube parts 201A, 201B.

Sub-step 207A in FIG. 10 reveals the glass tube 201 (illustrated in perspective view) with an arrangement of symmetrical modifications 209. The modifications 209 extend for example from the surface of the glass tube 201 radially into the latter. The modifications 209 are present in a zone 209A extending circularly around the glass tube, for example. In other words, the arrangement of modifications 209 extends around the glass tube 201 once, as is evident from the enlarged (unrolled) segment 211 of the surface of the glass tube 201. In the example in FIG. 10, each of the modifications 209 has been written rotationally symmetrically into the material of the glass tube 201, for example with the aid of a symmetrical Bessel-Gaussian beam, which, as a nondiffractive beam, forms the elongated focus zone in the material of the glass tube 201 for generating the modifications 209. A further enlarged view 211A of the unrolled segment 211 has schematically indicated that cracks 213 proceed from the modifications 209. The cracks 213 are randomly oriented and/or run (at least partly) to an increased extent between the modifications 209.

In sub-step 207A, the glass tube 201 is held in such a way that it can be rotated continuously by means of an axis of rotation, for example about the cylinder axis. The modified zone 209A of the glass tube 201 is heated continuously. This can be done by means of a flame 203A or a CO2 laser beam, for example. In this case, the rotational speed can be chosen such that no significant cooling occurs during a revolution of the glass tube 201. In this way, the glass tube 201 can be heated over the complete material thickness, with the result that the material of the glass tube 201 expands in this region.

In sub-step 207B, the surface of the glass tube 201 is then cooled as abruptly as possible. This can be done e.g. by cooling by means of a water-gas mixture 205A, which is sprayed onto the glass tube 201 over a large area with continued rotation of said glass tube.

Consequently, a considerably cooled temperature is present in the outer/near-surface region of the material of the glass tube 201 and a large temperature gradient forms with a minimum temperature at the surface of the glass tube 201 and a maximum temperature for example in the region of the zone 209A of the modifications 209 on the inner wall of the glass tube 201. As a result of the large temperature gradient, there prevails at the surface of the glass tube 201 a tensile stress (arrows 215) which causes an initial crack 217 that is as fully circumferential as possible to arise at the surface of the glass tube 201. The initial crack 217 runs along the introduced modifications 209 and may be based in part/in portions on the cracks 213 that had already arisen during the introduction of the modifications 209.

In sub-step 207C, the glass tube 201 is heated from outside (flame 203B) and optionally cooled from inside by means of a water-gas mixture 205B′ of a cooling source 205′. A temperature gradient then arises over the entire material thickness of the glass tube 201. The temperature gradient has the effect that the initial crack 217 can propagate through the wall of the glass tube 201.

In FIG. 10, sub-step 207C is additionally elucidated schematically on the basis of a cut-open tube with respect to the acting forces (arrows 219A for elucidating the stress owing to the cooling in the inner region of the glass tube 201; arrows 219B for elucidating the stress owing to the heating of the outer region of the glass tube 201).

The initial crack 217 transitions into a separating crack 221 extending completely through the wall of the glass tube 201. If the separating crack 221 runs completely around the glass tube 201, a complete separation of the glass tube into the parts 201A and 201B is present.

For the sake of completeness, it is pointed out that besides an intensity distribution in a focus zone which brings about a single symmetrical modification, a phase imposition can be performed by means of a diffractive optical element, for example, which results in an intensity distribution in the focus zone which brings about one asymmetrical modification (e.g. flattened in one direction) or a plurality of modifications running parallel to one another (see imaging depiction (c) in FIG. 1). In this case, the modification or the arrangement of modifications can be generated by means of one laser pulse or a group of laser pulses. Exemplary phase impositions and intensity distributions are disclosed e.g. in the applicant's German patent application 10 2019 128 362.0, “Segmented beam shaping element and laser processing apparatus”, with a filing date of Oct. 21, 2019, and also in K. Chen et al., “Generalized axicon-based generation of nondiffracting beams”, arXiv:1911.03103v1 [physics.optics] Nov. 8, 2019.

Such asymmetrical modifications or lined up modifications can likewise be used with the concepts disclosed herein for the processing of materials having curved surfaces. In other words, a beam shaping which is to be performed for such asymmetrical modifications can also be combined with a phase correction which can correct the influencing of the phase distribution upon entrance into the material.

FIG. 11 elucidates for such asymmetrical modifications, on the basis of the example of an elliptically flattened modification, a thermal separation process similar to the separation process described in association with FIG. 10, three corresponding sub-steps 307A, 307B, 307C being carried out. For details of the three sub-steps, reference is made to the above description of FIG. 10. Furthermore, the corresponding reference signs are used in FIG. 11, with the exception of asymmetrical modifications 309, a modification zone 309A extending along the modifications 309, and cracks 313 (see sub-step 207A in FIG. 11).

On account of the asymmetrical modifications 309, the cracks 313 can form to an increased extent along the lining up of the asymmetrical modifications 309. In comparison with randomly distributed cracks, the cracks 313 may partly overlap or at least project closer to one another (as elucidated in FIG. 11).

In sub-step 207B, an initial crack 317—similar to the initial crack 217 in FIG. 10—is shown which connects the asymmetrical modification 309 substantially along the cracks 313 and primarily on the top side of the glass tube 201. By virtue of the preferred direction of the cracks 313, it is thus possible to simplify the formation of the initial crack 317 in sub-step 207B and the formation of a separating crack 321 in sub-step 207C.

FIGS. 12A, 12B schematically elucidate processed workpieces in which a sequence of modifications was introduced into a tube wall along an inner contour as scanning trajectory.

As an example of a workpiece having constant curvature, FIG. 12A shows a tube portion 51 extending along a longitudinal direction (y-direction) and having a constant outer radius and a wall thickness in the range of 1 mm. A substantially circular opening 53 was produced in the tube portion 51 on a lateral surface (the outer surface of the tube portion 51) by a procedure in which a series of lined up modifications was written along a closed inner contour 55. During the writing process, a phase-correcting beam shaping, once set, was able to be maintained unchanged owing to the constant curvature. A wet etching process was carried out after the writing process, with the result that the region of the tube portion 51 in the interior of the inner contour 53 was completely separated from the surrounding material and could accordingly be removed. The ends 51A, 51B of the tube portion 51 as shown in FIG. 12A may each be the result of a circumferential contour cut.

As an example of a workpiece having varying curvature, FIG. 12B shows a conically tapering hollow body 57, in which the radius of curvature of an outer side of the wall increases in the y-direction; that is to say that the hollow body 57 decreases in terms of the radius along the y-direction by way of example linearly given a substantially constant wall thickness of 1 mm. During the processing of the surface of the hollow body 57, the curvature to be corrected correspondingly varies depending on the y-position.

As in FIG. 12A, a substantially circular opening 53′ was produced in the hollow body 57 by a procedure in which a series of lined up modifications was written into the wall along a closed inner contour 55′. Owing to the varying curvature, the phase-correcting beam shaping arose along the scanning trajectory.

By way of example, a y-dependent adaptation of the phase-correcting beam shaping can be performed on the basis of the known geometry of the hollow body 57. Alternatively, it is possible to detect the variation of the curvature during the processing along the scanning trajectory and to implement a corresponding setting of the phase-correcting beam shaping. Additionally or alternatively, it is furthermore possible, for the purpose of detecting the curvature, for the closed inner contour 55′ to be separately traversed once before the laser processing in order to store the corresponding curvature data in the control unit and to correspondingly set the phase-correcting beam shaping.

The ends 57A, 57B of the hollow body 57, too, may for example constitute the result of circumferential contour cuts, wherein each of the contour cuts can be carried out with a dedicated phase-correcting beam shaping in a manner adapted to the curvature respectively present.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for processing a workpiece using a pulsed laser beam, wherein the workpiece comprises a material and has a curved surface, the method comprising the following steps:
beam shaping of the laser beam to form an elongated focus zone in the material of the workpiece, wherein the beam shaping is carried out by using an arrangement of diffractive, reflective and/or refractive optical assemblies, and the beam shaping comprises:
focus-forming beam shaping to cause beam portions to enter at an entry angle to a beam axis of the laser beam for forming the elongated focus zone along the beam axis in the workpiece by way of interference, and
phase-correcting beam shaping to counteract any influence of the interference by entrance of the laser beam into the workpiece, and
setting beam parameters of the laser beam so that the material of the workpiece is modified in the elongated focus zone.

2. The method as claimed in claim 1, wherein the curved surface is curved in one direction, and
the beam shaping of the laser beam comprises imposing at least one two-dimensional phase distribution on the laser beam in order to form the elongated focus zone in the material of the workpiece, wherein the at least one phase distribution comprises:
for the focus-forming beam shaping, first phase contributions that cause the beam portions to enter at the entry angle and generate a nondiffractive beam for the formation of the elongated focus zone along the beam axis in the workpiece, and
for the phase-correcting beam shaping, second phase contributions that cancel an entrance phase locally accumulated by the laser beam during the entrance into the workpiece.

3. The method as claimed in claim 2, wherein the locally accumulated entrance phase is determined for an orientation of the beam axis along a normal direction relative to the surface at an impingement point of the beam axis on the surface based on:
the entry angle,
a radius of curvature of the surface at the impingement point and
a refractive index of the material of the workpiece.

4. The method as claimed in claim 2, wherein the second phase contributions form a phase distribution that is axially symmetrical with respect to an axis of symmetry, wherein the second phase contributions are constant parallel to the axis of symmetry and vary perpendicular to the axis of symmetry, and the method further comprising the following step:
orienting the axially symmetrical phase distribution and the workpiece with respect to each other so that the axis of symmetry runs orthogonally with respect to a plane in which a radius of curvature of the surface is defined.

5. The method as claimed in claim 2, wherein the first phase contributions and/or the second phase contributions are imposed on a transverse beam profile of the laser beam by a diffractive optical beam shaping element, wherein the diffractive optical beam shaping element has mutually adjoining surface elements that construct a planar grating structure, wherein each surface element is assigned a respective phase shift value so as to bring about the first phase contributions and/or the second phase contributions.

6. The method as claimed in claim 1, further comprising:
radiating the laser beam onto the surface along a beam path of an optical system that images the laser beam into the material of the workpiece in order to form the elongated focus zone, and/or
orienting a beam axis of the laser beam with respect to a normal direction relative to the surface so that the beam axis impinges on the surface in an angle range of 5° around the normal direction.

7. The method as claimed in claim 1, wherein the phase-correcting beam shaping is generated by a cylindrical lens positioned upstream or downstream of an optical assembly that brings about the focus-forming beam shaping in a beam path of the laser beam.

8. The method as claimed in claim 7, wherein the cylindrical lens has a radius of curvature that is adapted to a radius of curvature of the surface of the workpiece, such that the following holds true for the radius of curvature R_{z} of the cylindrical lens:
upon positioning of a beginning of the elongated focus zone upstream of the curved surface using the parameters a=5060 mm⁻², b=9645 mm⁻¹, and displacement Δ_{z} of the beginning of the elongated focus zone in a direction of propagation upstream of the curved surface:
$${R}_{z} ( Δ z \geq 0 , {R}_{w} ) \approx ( {n}_{z} - 1 ) \cdot [ ( b - a \cdot {R}_{w} ) \cdot {( Δ z )}^{2} - \frac{{M}^{2} \cdot {R}_{w}}{{n}_{w} - 1} ]$$
upon positioning of the beginning of the elongated focus zone in the direction of propagation downstream of the curved surface using the parameters c=284 mm⁻¹, d=590, and the displacement Δ_{z} of the beginning of the elongated focus zone upstream of the curved surface:
$${R}_{z} ( Δ z \leq 0 , {R}_{w} ) \approx ( {n}_{z} - 1 ) \cdot [ ( d - c \cdot {R}_{w} ) \cdot Δ z - \frac{{M}^{2} \cdot {R}_{w}}{{n}_{w} - 1} ]$$
upon positioning of the beginning of the elongated focus zone on the curved surface:
R_{z}≈(−1)R_{w}M²(n_{z}−1)/(n_{w}−1)
wherein
n_{z} is a refractive index of the cylindrical lens,
R_{w} is a radius of curvature of the surface,
n_{w} is a refractive index of the material of the workpiece, and
M is an imaging factor of the beam path between a location of the focus-forming beam shaping and the workpiece.

9. The method as claimed in claim 1, wherein the beam shaping of the laser beam with imposition of a two-dimensional phase distribution on a transverse beam profile of an output laser beam is carried out by:
a diffractive optical beam shaping element having fixedly set or settable phase values in a two-dimensional arrangement; or
a combination of a deformable cylindrical mirror with an axicon; or
a combination of a cylindrical lens with an axicon; or
a combination of a cylindrical lens or a deformable cylindrical mirror with a diffractive optical beam shaping element having fixedly set or settable phase values in a two-dimensional arrangement configured for imposing a Bessel-beam-like phase distribution, for the formation of the elongated focus zone.

10. The method as claimed in claim 1, wherein the beam shaping of the laser beam is carried out by a single optical assembly configured as a refractive freeform optical element, or as a hybrid optical unit comprising an input-side cylindrical lens and an output-side axicon.

11. The method as claimed in claim 1, further comprising:
bringing about a relative movement between the workpiece and the focus zone, wherein, during the relative movement, the focus zone is positioned along a scanning trajectory in the material of the workpiece, such that a plurality of modifications are written into the material of the workpiece along the scanning trajectory, wherein the scanning trajectory is an outer contour for subdividing the workpiece into two parts along a longitudinal axis of the workpiece or an inner contour for releasing a region delimited by the inner contour.

12. The method as claimed in claim 11, wherein the workpiece is configured as a tube, a cylinder, or a portion of a tube or a cylinder, and the relative movement comprises a rotational movement of the workpiece, and wherein the beam axis of the laser beam runs through a longitudinal axis of the workpiece.

13. The method as claimed in claim 11, wherein the relative movement comprises a rotational movement about a longitudinal axis of the workpiece, the scanning trajectory of the laser beam runs in a plane of maximum curvature of the surface of the workpiece, and/or wherein the relative movement comprises a translational movement in the direction of the longitudinal axis of the workpiece.

14. The method as claimed in claim 11, wherein the relative movement comprises a rotational movement about an axis of rotation, and the method further comprising:
monitoring and controlling a position of the surface of the workpiece along the beam axis to a target position, and
wherein the monitoring and controlling is carried out if the axis of rotation deviates from an axis of rotational symmetry of the surface of the workpiece and/or the surface of the workpiece deviates from a rotationally symmetrical surface course at least in portions.

15. The method as claimed in claim 11, further comprising:
adapting the phase-correcting beam shaping to a change in a curvature of the curved surface along the scanning trajectory of the laser beam, wherein
a control signal for adapting the phase-correcting beam shaping is derived based on a prior measurement of a curvature of the curved surface along the scanning trajectory and/or based on an online measurement of the curvature of the curved surface during a relative movement between the workpiece and the focus zone along the scanning trajectory.

16. An optical system for beam shaping of a pulsed laser beam for forming a focus zone in a workpiece having a curved surface, wherein the focus zone is elongated along a beam axis of the laser beam, the optical system comprising:
a focus-forming optical assembly, configured to cause beam portions to enter at an entry angle to the beam axis of the laser beam for forming the elongated focus zone along the beam axis in the workpiece by way of interference, and/or
a phase-correcting optical assembly, configured to impose a phase correction that counteracts any influence of the interference by entrance of the laser beam into the workpiece.

17. The optical system as claimed in claim 16, wherein the optical system is configured to impose a two-dimensional phase distribution on the laser beam and to output the laser beam as a real or virtual Bessel-like laser beam, wherein
the focus-forming optical assembly is configured to generate first phase contributions of the phase distribution, so as to generate a nondiffractive beam for forming the elongated focus zone along the beam axis in the workpiece, and
the phase-correcting optical assembly is configured to generate second phase contributions of the phase distribution so as to cancel an entrance phase locally accumulated by the laser beam during entrance into the workpiece.

18. The optical system as claimed in claim 16, wherein the focus-forming optical assembly and/or the phase-correcting optical assembly for imposition of a two-dimensional phase distribution are/is configured as a diffractive optical beam shaping element designed to impose the first phase contributions and/or the second phase contributions on a transverse beam profile of the laser beam, wherein the diffractive optical beam shaping element has mutually adjoining surface elements that construct a planar grating structure, wherein each surface element is assigned a respective phase shift value so as to bring about the first phase contributions and/or the second phase contributions; and/or
the focus-forming optical assembly is configured as an axicon that generates the focus-forming phase contributions; and/or
the phase-correcting optical assembly is configured as a cylindrical lens that generates the second phase contributions and is positioned directly upstream or downstream of the focus-forming optical assembly in the beam path of the laser beam; and/or
the focus-forming optical assembly is configured as a refractive freeform element that generates the first phase contributions and the second phase contributions; and/or
the focus-forming optical assembly and the phase-correcting optical assembly are configured as a hybrid optical assembly that generates the first phase contributions and the second phase contributions and is configured as a combination of an input-side cylindrical lens and an output-side axicon.

19. The optical system as claimed in claim 16, wherein the phase-correcting optical assembly comprises a diffractive optical beam shaping element configured for adapting the phase corrections in an event of a change in a curvature to be corrected of the curved surface depending on a control signal.

20. The optical system as claimed in claim 16, further comprising:
a telescope arrangement for reducing a real or virtual focus zone, that is assigned to the focus-forming optical assembly, and/or
a distance sensor configured to determine a position of a surface of the workpiece along the beam axis.

21. A laser processing apparatus for processing a workpiece using a pulsed laser beam by way of modifying a material of the workpiece that comprises a material and has a curved surface, the laser processing apparatus comprising:
a laser beam source, configured to emit a laser beam,
an optical system as claimed in claim 16, and
a workpiece mount for mounting the workpiece.

22. The laser processing apparatus as claimed in claim 21, wherein the optical system and/or the workpiece mount are/is designed:
to orient a beam axis of the laser beam with respect to a normal direction relative to the surface so that the beam axis impinges on the surface in an angle range of 5° around the normal direction, and/or
to bring about a relative movement between the workpiece and a focus zone of the laser beam, wherein, during the relative movement, the focus zone is positioned along a scanning trajectory in the material of the workpiece, wherein the orientation of the beam axis with respect to the normal direction is adapted to the course of the surface.

23. The laser processing apparatus as claimed in claim 21, further comprising:
a distance sensor configured to determine a position of the surface of the workpiece along the beam axis, and
a controller configured to monitor the position of the surface of the workpiece along the beam axis using the distance sensor and to control the position of the surface to a target position.

24. The laser processing apparatus as claimed in claim 21, wherein the optical system comprises a phase-correcting optical assembly for the phase imposition of a two-dimensional phase distribution, wherein the phase-correcting optical assembly is configured as settable in terms of the two-dimensional phase distribution, the laser processing apparatus further comprising:
a controller configured to output to the phase-correcting optical element a control signal that adapts the two-dimensional phase distribution to a curvature to be corrected of the curved surface of the workpiece,
wherein the control signal is derived based on a prior measurement of a curvature of the curved surface along a trajectory or based on an online measurement of the curvature of the curved surface during a relative movement between the workpiece and the focus zone along a scanning trajectory.

25. The laser processing apparatus as claimed in claim 21, further comprising:
a distance sensor configured to determine a position of a surface of the workpiece along the beam axis, and
a controller configured to monitor the position of the surface of the workpiece along the beam axis using the distance sensor and to control the position of the surface to a target position.
